(19) United States
(12) Patent Application Publication
(10) Pub. No.: US 2003/0189563 A1
(43) Pub. Date: Oct. 9, 2003

(54) Image display device

(76) Inventors: Hideo Sato, Hitachi (JP); Tomohiko Sato, Chiba (JP); Masahiro Maki, Mobara (JP); Toshio Miyazawa, Chiba (JP); Norio Mamba, Kawasaki (JP); Tsutomu Furuhashi, Yokohama (JP)

Correspondence Address: Reed Smith LLP, 3110 Fairview Park Drive, Suite 1400, Falls Church, VA, 22042, US

(21) Appl. No.: 10/404,105

(22) Filed: Apr. 2, 2003

(30) Foreign Application Priority Data
Apr. 9, 2002 (JP) 2002-106415

(51) Int. Cl. G09G 5/00

(52) U.S. Cl. 345/209

(57) ABSTRACT

An image display device which can simplify driving thereof includes a plurality of pixels which are arranged in a matrix array, each pixel including a first pixel electrode and a second pixel electrode, and a circuit which applies a first voltage which assumes either a positive polarity or a negative polarity with respect to a center voltage which is substantially fixed irrelevant to gray scale data and changes a magnitude thereof in response to the gray scale data to the first pixel electrode and, at the same time, applies a second voltage which assumes the other polarity with respect to the center voltage and changes a magnitude thereof in response to the gray scale data to the second pixel electrode.

### BACKGROUND OF THE INVENTION

The present invention relates to an image display device, and more particularly to an image display device formed of a liquid crystal display device, for example.

There has been known a liquid crystal display device which is configured such that a pair of substrates are arranged to face each other in an opposed manner by way of liquid crystal, on each pixel region formed on a liquid-crystal-side surface of one substrate out of such a pair of substrates, a first pixel electrode and a second pixel electrode which generate a lateral electric field in the liquid crystal are arranged, and signals are supplied to respective pixel electrodes through a first switching element and a second switching element (see JP-A-6-148596).

The condition of behavior of the liquid crystal is changed based on the electric field in response to the voltage difference between the first pixel electrode and the second pixel electrode thus changing the optical transmissivity of the liquid crystal.

Here, the above-mentioned liquid crystal display device described in JP-A-6-148596 is configured such that with respect to a pixel region in a matrix array of n rows and m columns, n pieces of scanning lines (gate signal lines) and (m+1) pieces of signal lines (drain signal lines) which cross these scanning lines are provided. Here, two switching elements are provided per one pixel region, wherein gate electrodes of these two switching elements are connected to the same gate signal line.

In the pixel regions of the (i)th column, the drain electrode of the first switching element is connected to the (i)th drain signal line and the source electrode of the first switching element is connected to the first pixel electrode. Further, the drain electrode of the second switching element is connected to the (i+1)th drain signal line and the source electrode of the second switching element is connected to the second pixel electrode.

Further, in the pixel regions of the (i+1)th column, the drain electrode of the first switching element is connected to the (i+1)th drain signal line and the source electrode of the first switching element is connected to the first pixel electrode. Further, the drain electrode of the second switching element is connected to the (i+2)th drain signal line and the source electrode of the second switching element is connected to the second pixel electrode.

Accordingly, the (i+1)th drain signal line is used in common by the pixel regions of the (i)th column and the pixel regions of (i+1)th column. Then, by repeating the similar constitution, the first to the (m+1)th drain signal lines are allocated to the pixel regions of the 1st column to the (m)th column.

Here, by applying the scanning signal to the gate signal line so as to operate the switching element and, at the same time, by applying a given video signal to the (i)th, the (i+1)th and the (i+2)th drain signal lines, the voltage is written in the first and the second pixel electrodes of the pixel regions of the (i)th column and the pixel regions of the (i+1)th column, wherein display is performed by controlling the behavior of the liquid crystal based on the electric field in the lateral direction (direction horizontal to the substrate surface) which is generated between the first and second pixel electrodes.

However, when the (i+1)th drain signal line is used in common by the pixel regions of the (i)th column and the pixel regions of the (i+1)th column, the same voltage is written in the second pixel electrodes of the pixel regions of the (i)th column and the first pixel electrodes of the pixel regions of the (i+1)th column. Accordingly, to enable the pixel regions of the (i)th column and the pixel regions of the (i+1)th column to perform a desired display, it is necessary to determine the video signal to be applied to the (i)th and the (i+2)th drain signal lines by calculating the difference from the video signal applied to the (i+1)th drain signal line.

Further, with respect to the (i+2)th drain signal line, the same voltage is also written in the first pixel electrode of the pixel regions of the (i+2)th column which is arranged next to the (i+2)th drain signal line and hence, to determine the video signal to be applied to the (i+3)th drain signal line, it is necessary to calculate the corresponding difference.

In this manner, writing of the voltage influences the pixel regions of the neighboring column and hence, to determine the video signals to be applied from the 1st to the (m+1)th drain signal lines, it is necessary to perform the extremely complicated calculation. Further, the dynamic range which is necessary for the video signals to be applied becomes extremely large.

Accordingly, the liquid crystal display device having such a constitution requires the complicated driving thereof.

The present invention has been made under such circumstances and it is an object of the present invention to provide an image display device which can simplify driving thereof.

### SUMMARY OF THE INVENTION

To briefly explain the summary of typical inventions among inventions disclosed by the present application, they are as follows.

Means 1.

The image display device according to the present invention comprises, for example,

a plurality of pixels which are arranged in a matrix array, each pixel including a first pixel electrode and a second pixel electrode, and

a circuit which applies a first voltage which assumes either one of a positive polarity and a negative polarity with respect to a center voltage which is substantially fixed irrelevant to gray scale data and changes a magnitude thereof in response to the gray scale data to the first pixel electrode and, at the same time, applies a second voltage which assumes another one of the positive polarity and the negative polarity with respect to the center voltage and changes a magnitude thereof in response to the gray scale data to the second pixel electrode.

Means 2.

The image display device according to the present invention is, for example, based on the constitution of means 1 and is characterized in that the circuit inverts the polarity of the second voltage with respect to the first voltage in each pixel for every one frame or two or more frames.

Means 3.

The image display device according to the present invention is, for example, based on the constitution of means 1 or 2 and is characterized in that each pixel includes a first switching element and a second switching element, the first voltage is written in the first pixel electrode through the first switching element, and the second voltage is written in the second pixel electrode through the second switching element.

Means 4.

The image display device according to the present invention comprises, for example,

a plurality of pixels which are arranged in a matrix array of n rows and m columns,

n gate signal lines,

2m drain signal lines, wherein two drain signal lines consisting of a first drain signal line and a second drain signal line are made to correspond to one row of the plurality of pixels, and

a video driving circuit which applies a first signal to the first drain signal lines and a second signal to the second drain signal lines, wherein

each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element,

the first signal is a first voltage which is a voltage having either one of a positive polarity and a negative polarity with respect to a center voltage which is substantially fixed irrelevant to gray scale data and changes a magnitude thereof in response to the gray scale data, and

the second signal is a second voltage which is a voltage having another of the positive polarity and the negative polarity with respect to the center voltage and changes a magnitude thereof in response to the gray scale data.

Means 5.

The image display device according to the present invention is, for example, based on the constitution of means 4 and is characterized in that the video driving circuit includes an alternating circuit which inverts the polarity of the second signal with respect to the first signal applied to each drain signal line for every one frame or two or more frames.

Means 6.

The image display device according to the present invention comprises, for example,

a plurality of pixels which are arranged in a matrix array of n rows and m columns,

n gate signal lines,

2m drain signal lines, wherein two drain signal lines consisting of a first drain signal line and a second drain signal line are made to correspond to one row of the plurality of pixels, and

a video driving circuit which applies a first signal to the first drain signal lines and a second signal to the second drain signal lines, wherein

each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element,

the first signal is either one of a reference voltage which is substantially fixed irrelevant to gray scale data and a first voltage which has one polarity with respect to the reference voltage and changes a magnitude thereof in response to the gray scale data, and

the second signal is another of the reference voltage and the first voltage.

Means 7.

The image display device according to the present invention is, for example, based on the constitution of means 6 and is characterized in that the video driving circuit includes an alternating circuit which changes over the first signal applied to the first drain signal line to either the reference voltage or the first voltage for every one frame or two or more frames.

Means 8.

The image display device according to the present invention comprises, for example,

a plurality of pixels which are arranged in a matrix array of n rows and m columns,

n gate signal lines,

2m drain signal lines, wherein two drain signal lines consisting of a first drain signal line and a second drain signal line are made to correspond to one row of the plurality of pixels, and

a video driving circuit which applies a first signal to the first drain signal lines and a second signal to the second drain signal lines, wherein

each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element, and

the video driving circuit changes over

a first state in which the first signal is either one of a first reference voltage which is substantially fixed irrelevant to gray scale data and a first voltage which has one polarity with respect to the first reference voltage and changes a magnitude thereof in response to the gray scale data, and the second signal is another of the first reference voltage and the first voltage, and

a second state in which the first signal is either one of a second reference voltage which is substantially fixed irrelevant to the gray scale data and is different from the first reference voltage and a second voltage which has another polarity with respect to the second reference voltage and changes a magnitude thereof in response to the gray scale data, and the second signal is another of the second reference voltage and the second voltage.

Means 9.

The image display device according to the present invention is, for example, based on the constitution of means 8 and is characterized in that the video driving circuit changes over the first state and the second state for every one frame or two or more frames.

Means 10.

The image display device according to the present invention comprises, for example,

a plurality of pixels which are arranged in a matrix array of n rows and m columns,

n first gate signal lines to which scanning signals for pixels of odd columns out of the plurality of pixels are applied,

n second gate signal lines to which scanning signals for pixels of even columns out of the plurality of pixels are applied,

(m+1) drain signal lines in which the first drain signal line is used corresponding to the pixels of the first column, the (m+1)th drain signal line is used corresponding to the pixels of the (m)th column, and each drain signal line from the second to (m)th drain signal lines is used in common for columns of pixels which are arranged at both sides of the drain signal line whereby two drain signal lines correspond to one pixel,

a scanning driving circuit which applies the scanning signals to the first gate signal lines and the second gate signal lines, and

a video driving circuit which applies video signals to the drain signal lines.

Means 11.

The image display device according to the present invention is, for example, based on the constitution of means 10 and is characterized in that each pixel includes a first switching element and a second switching element which are operated in response to the common first gate signal line or second gate signal line, a first pixel electrode to which the video signal is supplied from corresponding one drain signal line through the first switching element, and a second pixel electrode to which the video signal is supplied from corresponding another drain signal line through the second switching element.

Means 12.

The image display device according to the present invention is, for example, based on the constitution of means 10 or 11 and is characterized in that the video signal which is applied to one drain signal line out of the two drain signal lines which correspond to one pixel is a first voltage which is a voltage having either one of a positive polarity and a negative polarity with respect to a center voltage which is substantially fixed irrelevant to gray scale data and changes a magnitude thereof in response to the gray scale data, and

the video signal which is applied to another drain signal line out of the two drain signal lines which correspond to one pixel is a second voltage which is a voltage having another of the positive polarity and the negative polarity with respect to the center voltage and changes a magnitude thereof in response to the gray scale data.

Means 13.

The image display device according to the present invention is, for example, based on the constitution of means 12 and is characterized in that the video driving circuit includes an alternating circuit which inverts the polarity of the video signal applied to another drain signal line with respect to the video signal applied to one drain signal line for every one frame or two or more frames.

Means 14.

The image display device according to the present invention is, for example, based on the constitution of means 10 or 11 and is characterized in that the video signal which is applied to one drain signal line out of the two drain signal lines which correspond to one pixel is either one of a reference voltage which is substantially fixed irrelevant to gray scale data and a first voltage which has one polarity with respect to the reference voltage and changes a magnitude thereof in response to the gray scale data, and

the video signal which is applied to another drain signal line out of the two drain signal lines which correspond to one pixel is another of the reference voltage and the first voltage.

Means 15.

The image display device according to the present invention is, for example, based on the constitution of means 14 and is characterized in that the video driving circuit includes an alternating circuit which changes over the video signal applied to one drain signal line to either the reference voltage or the first voltage for every one frame or two or more frames.

Means 16.

The image display device according to the present invention is, for example, based on the constitution of means 10 or 11 and is characterized in that the video driving circuit changes over

a first state in which the video signal which is applied to one drain signal line out of the two drain signal lines which correspond to one pixel is either one of a first reference voltage which is substantially fixed irrelevant to gray scale data and a first voltage which has one polarity with respect to the first reference voltage and changes a magnitude thereof in response to the gray scale data, and the video signal which is applied to another drain signal line out of the two drain signals which correspond to one pixel is another of the first reference voltage and the first voltage, and

a second state in which the video signal which is applied to one drain signal line out of the two drain signal lines which correspond to one pixel is either one of a second reference voltage which is substantially fixed irrelevant to the gray scale data and is different from the first reference voltage and a second voltage which has the other polarity with respect to the second reference voltage and changes a magnitude thereof in response to the gray scale data, and the video signal which is applied to another drain signal line out of the two drain signal lines which correspond to one pixel is another of the second reference voltage and the second voltage.

Means 17.

The image display device according to the present invention is, for example, based on the constitution of means 16 and is characterized in that the video driving circuit changes over the first state and the second state for every one frame or two or more frames.

Means 18.

The image display device according to the present invention comprises, for example, a plurality of pixels which are arranged in a column direction as well as in a row direction, wherein

gate signal lines which select respective pixels arranged in odd columns and gate signal lines which select respective pixels arranged in even columns are separately provided, and

each pixel includes a pair of switching elements which are operated in response to scanning signals from the gate signal line, and a pair of pixel electrodes to which video signals are supplied from respective drain signal lines which are respectively arranged at both sides of the pixel through the pair of switching elements.

Means 19.

The image display device according to the present invention is, for example, based on the constitution of means 18 and is characterized in that each pixel arranged in the row direction is positioned between the gate signal line which selects each pixel arranged in the odd column in the row and the gate signal line which selects each pixel arranged in the even column in the row.

Means 20.

The image display device according to the present invention is, for example, based on the constitution of means 18 or 19 and is characterized in that out of the respective drain signal lines, from the drain signal lines at one side, signals which constitute the reference with respect to the video signals of the drain signal lines at another side are supplied.

Means 21.

The image display device according to the present invention comprises, for example,

a plurality of pixels which are arranged in a matrix array of n rows and m columns,

n gate signal lines,

m drain signal lines, and

n counter voltage signal lines which are formed along the extending direction of the gate signal lines, wherein

each pixel includes a first switching element and a second switching element which are operated in response to the common gate signal line, a first pixel electrode to which video signals are supplied from the drain signal line through the first switching element, and a second pixel electrode to which a reference voltage is supplied from the counter voltage signal line through the second switching element, and

a first reference voltage and a second reference voltage which differ from each other in voltage are alternately supplied to the counter voltage signal lines every one or more lines.

Means 22.

The image display device according to the present invention is, for example, based on the constitution of means 21 and is characterized in that the image display device includes a video signal driving circuit which changes over polarities of the video signals to be applied to the drain signal lines every horizontal period which is equal to the number of alternating first reference voltage and second reference voltage.

Means 23.

The image display device according to the present invention is, for example, based on the constitution of means 21 or 22 and is characterized in that the image display device includes a common circuit which changes over the reference voltage applied to respective counter voltage signal lines from one to another out of the first reference voltage and the second reference voltage for every one frame or two or more frames.

Means 24.

The image display device according to the present invention is, for example, based on the constitution of any one of means 1 to 23 and is characterized in that the pixels are pixels of a liquid crystal display device.

Here, the present inventions are not limited to the above-mentioned constitutions and various modifications can be made without departing from the technical concept of the present inventions.

### BRIEF DESCRIPTION OF THE DRAWINGS

FIG. 1 is a schematic constitutional view showing one embodiment of an image display device according to the present invention.

FIG. 2 is an equivalent circuit diagram showing one embodiment of the constitution of a pixel of the image display device shown in FIG. 1.

FIG. 3 is a timing waveform chart showing scanning signals and video signals supplied to the pixel shown in FIG. 2.

FIG. 4A to FIG. 4B are graphs showing gray scale voltages supplied to a pair of pixel electrodes shown in FIG. 2.

FIG. 5 is a timing waveform chart showing the relationship among a gate line voltage, a drain line voltage and a pixel voltage supplied to the pixel shown in FIG. 2.

FIG. 6 is a circuit diagram showing one embodiment of the constitution of a video driving circuit shown in FIG. 1.

FIG. 7 is a circuit diagram showing another embodiment of the constitution of a video driving circuit shown in FIG.

FIG. 8 is a timing waveform chart showing the relationship of the signals generated in the video driving circuits shown in FIG. 6 or FIG. 7.

FIG. 9A to FIG. 9B are graphs showing another embodiment of gray scale voltages supplied to a pair of pixel electrodes.

FIG. 10 is a circuit diagram showing another embodiment of the constitution of the video driving circuit shown in FIG. 1.

FIG. 11 is a schematic constitutional view showing another embodiment of the image display device according to the present invention.

FIG. 12 is a circuit diagram showing one embodiment of the constitution of a video driving circuit shown in FIG. 11.

FIG. 13 is a circuit diagram showing another embodiment of the constitution of the video driving circuit shown in FIG. 11.

FIG. 14 is a schematic constitutional view showing another embodiment of the image display device according to the present invention.

FIG. 15 is an equivalent circuit diagram showing one embodiment of the constitution of a pixel of the image display device shown in FIG. 14.

FIG. 16 is a timing waveform chart showing scanning signals and video signals supplied to the pixel shown in FIG. 15.

FIG. 17 is a view showing the sequence of writing voltage to respective pixels shown in FIG. 15.

FIG. 18 is a circuit diagram showing one embodiment of the constitution of the video driving circuit shown in FIG. 14.

FIG. 19 is a circuit diagram showing another embodiment of the constitution of the video driving circuit shown in FIG. 14.

FIG. 20 is a constitutional view showing another embodiment of the constitution of the video driving circuit shown in FIG. 14.

FIG. 21A and FIG. 21B are views showing the relationship between gray scale data and video signals used in the video driving circuit shown in FIG. 20.

FIG. 22 is a timing waveform chart showing the relationship between a gate line voltage, a drain line voltage and a pixel voltage supplied to each pixel using the video driving circuit shown in FIG. 20.

FIG. 23 is a schematic constitutional view showing another embodiment of the image display device according to the present invention.

FIG. 24 is an equivalent circuit diagram showing one embodiment of the constitution of a pixel of the image display device shown in FIG. 23.

FIG. 25 is a circuit diagram showing one embodiment of the constitution of a common circuit shown in FIG. 23.

FIG. 26 is a timing waveform chart showing the relationship between an output from the common circuit shown in FIG. 25 and other signals.

FIG. 27 is a timing waveform chart showing the relationship between a gate line voltage, a drain line voltage, a counter voltage signal line voltage and a pixel voltage supplied to a pixel shown in FIG. 24.

FIG. 28 is a circuit diagram showing one embodiment of the constitution of a video driving circuit shown in FIG. 23.

FIG. 29A and FIG. 29B are views showing gray scale voltages supplied to a pair of pixel electrodes of each pixel shown in FIG. 24.

FIG. 30 is a circuit diagram showing another embodiment of the constitution of the video driving circuit shown in the embodiment 1.

### DESCRIPTION OF THE PREFERRED EMBODIMENTS

Preferred embodiments of a liquid crystal display device which constitutes an image display device according to the present invention are explained hereinafter in conjunction with drawings.

Here, the liquid crystal display device explained hereinafter is a so-called active matrix type liquid crystal display device, for example, wherein a so-called low-temperature polysilicon is used as a material of a semiconductor layers of each transistor element formed in the liquid crystal display device. However, the material of the semiconductor layer is not limited to the low-temperature polysilicon and the present invention is applicable to the liquid crystal display device which uses the semiconductor layers made of amorphous silicon, for example.

Embodiment 1.

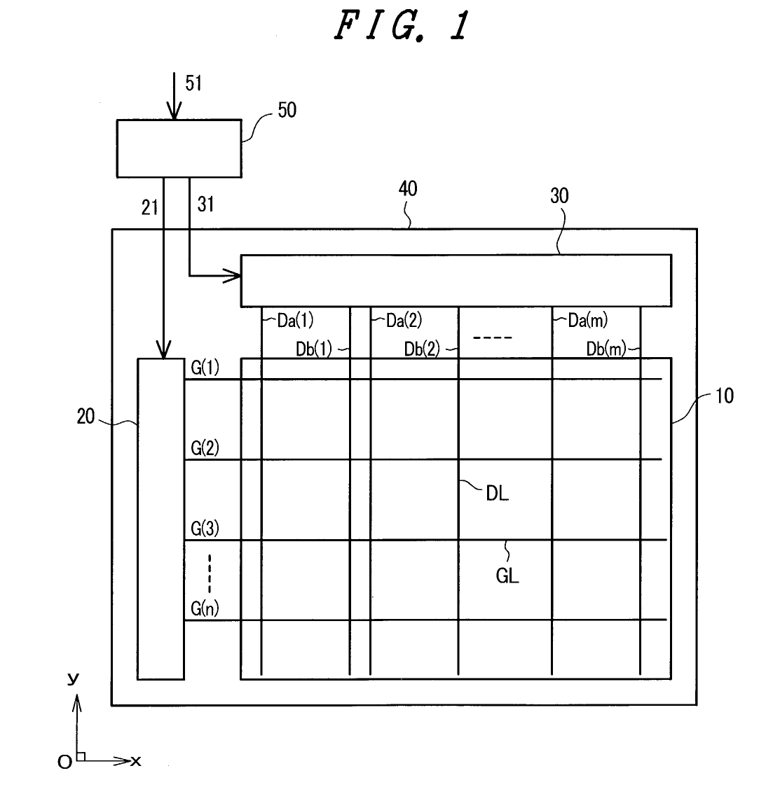

FIG. 1 is a schematic constitutional view showing one embodiment of an image display device according to the present invention.

Out of a pair of substrates which are arranged to face each other in an opposed manner by way of liquid crystal, on a liquid-crystal-side surface of one substrate, gate signal lines GL which extend in the x direction and are arranged in parallel in the y direction and drain signal lines DL which extend in the y direction and are arranged in parallel in the x direction are formed.

The respective gate signal lines GL have at least one-end sides thereof connected to a scanning driving circuit 20 and scanning signals G(1), G(2), . . . , G(n) are sequentially supplied to the respective gate signal lines GL by the scanning driving circuit 20.

Further, the respective drain signal lines DL have at least one-end sides thereof connected to a video driving circuit 30 and video signals Da(1), Db(1), Da(2), Db(2), . . . , Da(m), Db(m) are supplied from the left side in the drawing, for example, by the video driving circuit 30 at the timing of supplying the above-mentioned scanning signals G.

Each region which is surrounded by a pair of gate signal lines GL which are arranged close to each other and a pair of drain signal lines DL which are arranged to close to each other and to which the video signals Da, Db are supplied is defined as a pixel region and a liquid crystal display part 10 is constituted of a mass of these pixel regions.

Accordingly, with respect to the pixel regions in a matrix array of n rows and m columns, n gate signal lines GL and 2m drain signal lines DL are provided.

Further, to the above-mentioned scanning driving circuit 20 and video driving circuit 30, scanning driving control signals 21 and video driving control signals 31 are respectively inputted from a timing control circuit 50 so that the above-mentioned scanning signals G and the video signals Da, Db are outputted from the scanning driving circuit 20 and the video driving circuit 30. Here, numeral 51 indicates external input signals such as power supply and display data.

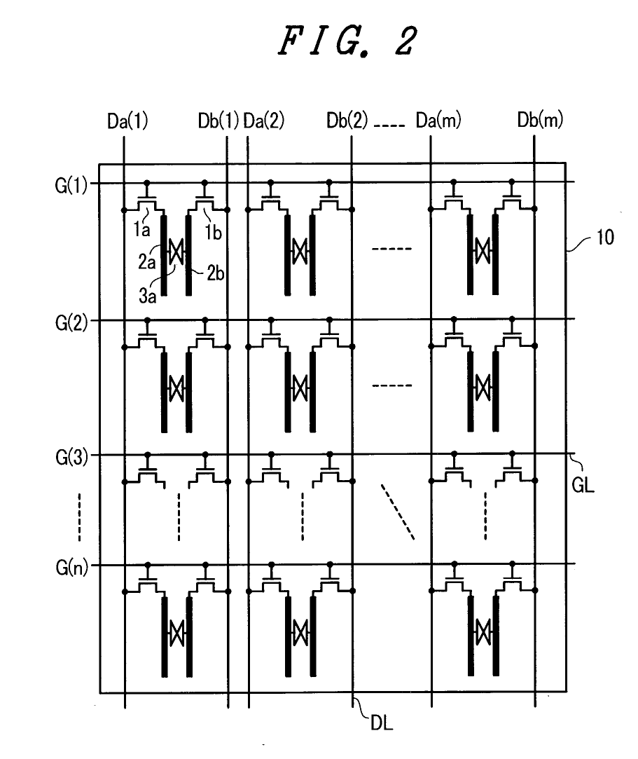

FIG. 2 is an equivalent circuit diagram showing one embodiment of the constitution of respective pixel regions in the above-mentioned liquid crystal display part 10.

In each pixel region, first of all, a pair of thin film transistors 1a, 1b which are operated in response to the scanning signal G(i) (i=1, 2, . . . ) from the gate signal line GL are arranged. These thin film transistors 1a, 1b are respectively constituted of a MIS (metal insulator semiconductor) type transistor and gate electrodes of these transistors 1a, 1b are connected to the above-mentioned gate signal lines GL.

Further, out of respective electrodes of the thin film transistor 1a except for the gate electrode, one electrode (referred to as a drain electrode for the sake of convenience) is connected to the drain signal line DL to which the video signal Da is supplied, while out of respective electrodes of the thin film transistor 1b except for the gate electrode, one electrode (referred to as a drain electrode for the sake of convenience) is connected to the drain signal line DL to which the video signal Db is supplied.

Further, out of respective electrodes of the thin film transistor 1a except for the gate electrode, the pixel electrode 2a is connected to another electrode (referred to as a source electrode for the sake of convenience), while out of respective electrodes of the thin film transistor 1b except for the gate electrode, the pixel electrode 2b is connected to another electrode (referred to as a source electrode for the sake of convenience).

Liquid crystal 3a is present between the pixel electrode 2a and the pixel electrode 2b and the liquid crystal 3a is operated by an electric field generated due to the voltage difference between the pixel electrode 2a and the pixel electrode 2b such that the optical transmissivity of the liquid crystal is changed.

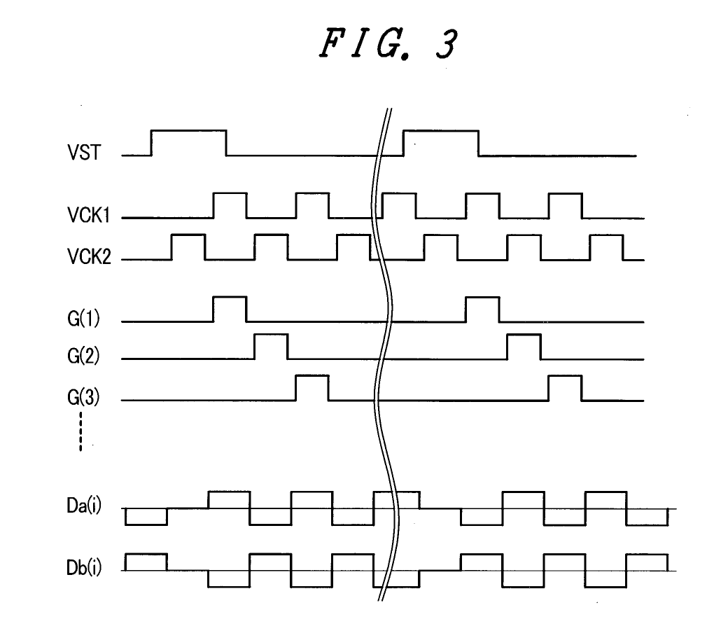

FIG. 3 is a timing waveform chart showing one embodiment of the relationship between the scanning signals G(1), G(2), G(3), . . . and the video signals Da(i), Db(i), (i=1, 2, 3, . . . ).

Here, VST indicates a start signal and VCK1 and VCK2 indicate clock signals and these signals constitute a portion of the above-mentioned scanning driving control signals 21.

As can be clearly understood from the drawing, phases of the scanning signals G(1), G(2), G(3), . . . are sequentially changed in synchronism with the clock signals VCK1 and VCK2. Further, the (i)th video signals Da(i), Db(i) have polarities which are opposite to each other and these polarities are changed over for every period of the start signal VST so that a so-called alternating is performed.

Accordingly, for example, the video signals Da, Db which are supplied to each pixel region driven by the scanning signal G(1) of the 1st row have the polarity in the succeeding frame which is opposite to the polarity of the preceding frame. Further, in the drawing, the polarities of the video signals Da(i), Db(i) are changed over also for every 1 horizontal period.

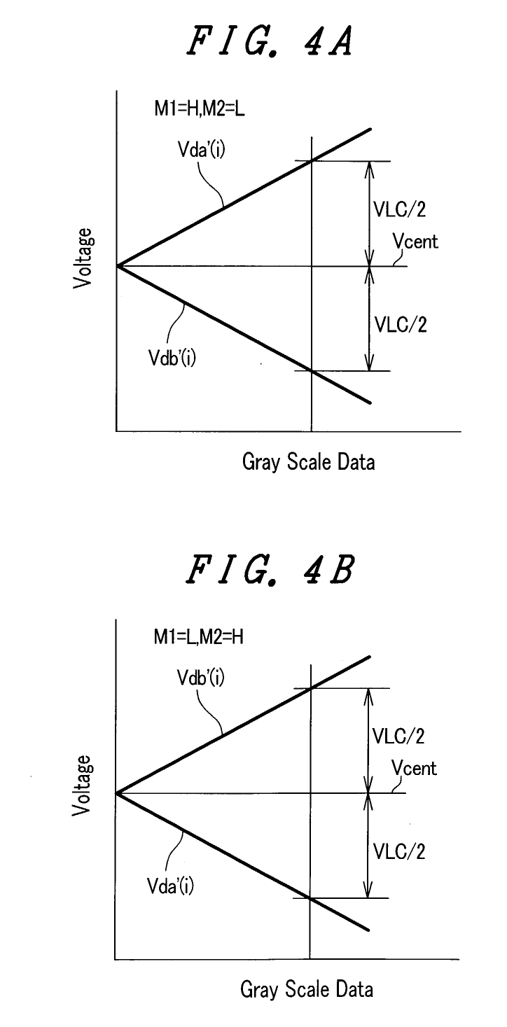

FIG. 4A and FIG. 4B are graphs showing gray scale voltages Vda′(i), Vdb′(i) which are supplied to a pair of pixel electrodes.

FIG. 4A shows a case in which AC signals are set to M1=H, M2=L. With respect to the gray scale voltage Vda′(i) of the video signal Da(i), the voltage is elevated in a rectilinear manner in response to the gray scale data using the center voltage Vcent as the reference, while with respect to the gray scale voltage Vdb′(i) of the video signal Db(i), the voltage is in a rectilinear manner lowered in response to the gray scale data using the center voltage Vcent as the reference.

When the gray scale data is given as shown in the drawing, the gray scale voltage Vda′(i) of the video signal Da(i) supplied to the pixel electrode 2a side assumes VLC/2 in the+direction with respect to the center voltage Vcent, while the gray scale voltage Vdb′(i) of the video signal Db(i) supplied to the pixel electrode 2b side assumes VLC/2 in the−direction with respect to the center voltage Vcent.

Due to such a constitution, the potential difference between the pixel electrode 2a and the pixel electrode 2b becomes VLC so that the liquid crystal 3a is operated with intensity of electric field corresponding to such a potential difference.

FIG. 4B shows a case in which AC signals are set to M1=L, M2=H. With respect to the gray scale voltage Vda′(i) of the video signal Da(i), the voltage is lowered in a rectilinear manner in response to the gray scale data using the center voltage Vcent as the reference, while with respect to the gray scale voltage Vdb′(i) of the video signal Db(i), the voltage is in a rectilinear manner elevated in response to the gray scale data using the center voltage Vcent as the reference.

Here, although the explanation has been made with respect to cases in which both of gray scale voltages Vda′(i), Vdb′(i) are in a rectilinear manner elevated or lowered, the characteristics of these gray scale voltages are not limited to such characteristics and it is needless to say that these gray scale voltages can have gently-curving characteristics.

Here, the center voltage Vcent is substantially set to a fixed value irrelevant to the gray scale data.

Due to such a constitution, with respect to the pixel voltage applied between respective pixel electrodes 2a, 2b, the voltages which are respectively supplied to respective thin film transistors, 1a, 1b are lowered to approximately ½ of the pixel voltage so that the operating voltages of the thin film transistors 1a, 1b can be lowered.

Further, to the contrary, with respect to the output voltage of the video driving circuit 30, it is possible to increase the voltage applied to the liquid crystal 3a by approximately twice so that it is possible to achieve the high speed response and the enhancement of numerical aperture.

Further, since the voltage supplied to the drain signal line DL in each pixel is completely the differential voltage and hence, the irradiation noise generated from the drain signal line DL can be largely reduced.

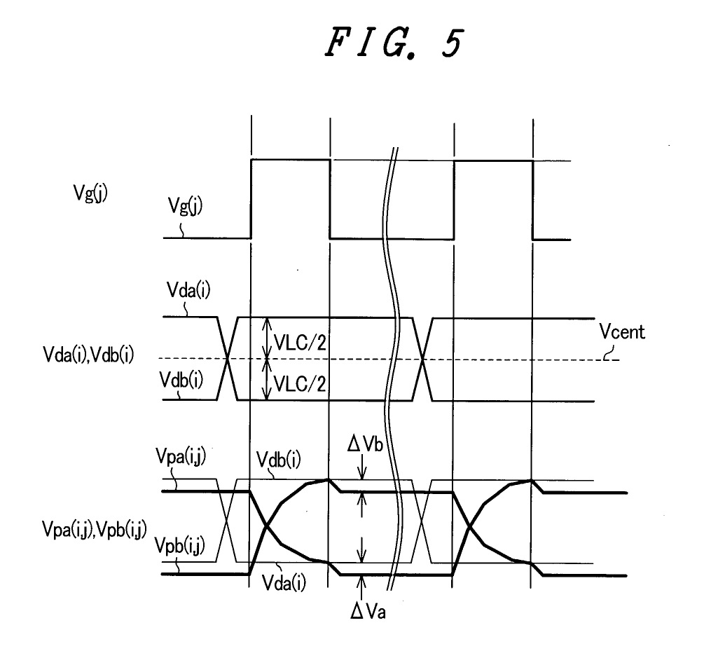

FIG. 5 is a timing waveform chart showing the relationship among the gate line voltage Vg(j) applied to the gate signal line GL, the drain line voltages Vda(i), Vdb(i) applied to each drain signal line DL and the pixel voltages Vpa(i, j), Vpb(i, j) of the pixel electrode 2a and the pixel electrode 2b in the pixel arranged at the j-th row and the (i)th column.

The gray scale voltages Vda′(i), Vdb′(i) which respectively correspond to the gray scale data are applied to a pair of drain signal lines DL. Accordingly, the drain line voltages Vda(i), Vdb(i) are respectively formed such that they have polarities opposite to each other with respect to the center voltage Vcent as the center and the independent drain line voltages Vda(i), Vdb(i) have their polarities inverted during a period that the gate line voltage Vg(j) is inputted. Here, the inversion of the polarities means that the relationship of magnitude of the drain line voltages Vda(i) and Vdb(i) is reversed.

The pixel voltages Vpa(i, j), Vpb(i, j) respond such that the pixel voltages Vpa(i, j), Vpb(i, j) assume the equal value with the drain line voltages Vda(i), Vdb(i) respectively when the gate line voltage Vg(j). assumes “H” level.

When the gate line voltage Vg(j) is changed from “H” to “L”, the pixel voltages Vpa(i, j), Vpb(i, j) are lowered by ΔVa, ΔVb through a so-called feed-through.

Here, the change of voltage due to the feed-through depends on respective amplitudes of the drain line voltages Vda(i), Vdb(i) and the gate line voltage Vg(j) and hence, when there exists the relationship Vda(i)≠Vdb(i), the relationship ΔVa≠ΔVb is established.

This implies that the pixel voltage difference (Vpa(i, j)−Vpb(i, j)) is changed by the feed-through voltage difference (ΔVa−ΔVb).

On the other hand, when the display is performed using the same gray scale data in the succeeding frame, the polarities of the drain line voltages Vda(i), Vdb(i) are changed at a period that the next gate line voltage Vg(j) is inputted and hence, the feed-through voltages ΔVa, ΔVb of pixel electrodes 2a, 2b respectively assume values different from the values in the preceding frame. That is, the next feed-through voltage ΔVa is equal to the feed-through voltage ΔVb in the preceding frame and the next feed-through voltage ΔVb is equal to the feed-through voltage ΔVa in the preceding frame.

However, this feed-through voltage difference (ΔVa−ΔVb) assumes the value whose polarity is inverted and whose absolute value is equal and hence, a direct-current components due to the feed-through becomes zero and hence, it is possible to obviate drawbacks such as flickering and sticking attributed to the direct-current components. Accordingly, the high quality display can be realized.

Although the polarities of the drain line voltages Vda(i), Vdb(i) are inverted every frame in this embodiment, the same advantageous effect can be obtained even when the polarities of the drain line voltages Vda(i), Vdb(i) are inverted every two frames or every three or more frames, for example.

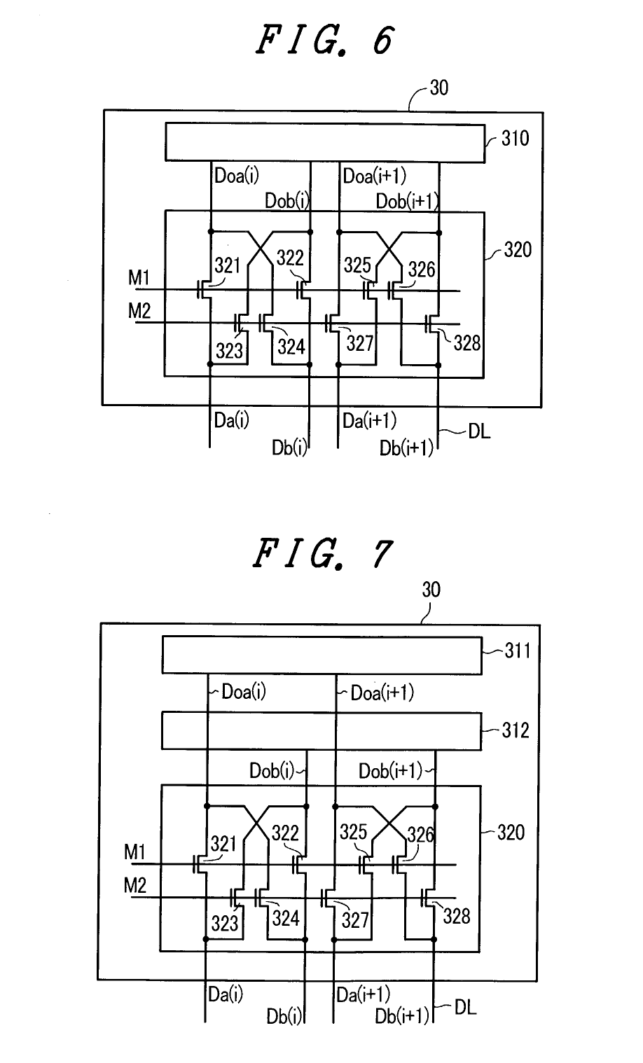

FIG. 6 is a circuit diagram showing one embodiment of the constitution of the above-mentioned video driving circuit 30.

The video driving circuit 30 is constituted of the drain driver 310 and the alternating circuit 320.

For the sake of brevity, there is shown a case in which the video signals Da(i), Db(i), Da(i+1), Db(i+1) are supplied to respective drain signal lines DL at the (i)th column and (i+1)th column from the drain driver 310.

The signal Doa(i) having the positive polarity and the signal Dob(i) having the negative polarity are respectively supplied to a pair of drain signal lines DL at the pixels of the (i)th column, while the signal Doa(i+1) having the positive polarity and the signal Dob(i+1) having the negative polarity are respectively supplied to a pair of drain signal lines DL at the pixels of the (i+1)th column.

To the alternating circuit 320, the alternating signals M1, M2 are inputted together with the above-mentioned signals Doa(i), Dob(i), Doa(i+1), Dob(i+1).

The alternating signals M1, M2 are inputted with the relationship of logic inversion such that when one signal assumes “H”, another signal assumes “L”.

Then, when the alternating signal M1 assumes “H” and the alternating signal M2 assumes “L”, the transistors 321, 322, 325, 326 assume the ON state and the transistors 323, 324, 327, 328 assume the OFF state.

On the other hand, when the alternating signal M1 assumes “L” and the alternating signal M2 assumes “H”, the transistors 323, 324, 327, 328 assume the ON state and the transistors 321, 322, 325, 326 assume the OFF state and are inverted.

As a result, to respective drain signal lines DL to which the video signals Da(i), Db(i), Da(i+1), Db(i+1) are supplied, when the alternating signal M1 assumes “H”, the signals Doa(i), Dob(i), Dob(i+1), Doa(i+1) are outputted, while when the alternating signal M1 assumes “L”, the signals Dob(i), Doa(i), Doa(i+1), Dob(i+1) are outputted.

The video driving circuit 30 having such a constitution has the alternating circuit 320 separately from the drain driver 310 and hence, it is unnecessary for the drain driver 310 to perform the alternating by itself. Accordingly, in the drain driver 310, it is possible to always set the output signals Doa(i), Doa(i+1) to a positive polarity and the output signals Dob(i), Dob(i+1) to a negative polarity. Due to such a provision, it is possible to obtain advantageous effects that the drain driver 310 can simplify the constitution thereof and, at the same time, can reduce the power consumption.

Further, it is also possible to realize the alternating circuit 320 having the simple constitution obviating the complicated constitution.

Further, by making the constitutions of the transistors 321 to 328 in the (i)th column and the (i+1)th column different from each other, the electric fields applied to respective liquid crystals in the pixels of the (i)th column and the pixels of the (i+1)th column have polarities opposite to each other. Accordingly, by inverting the alternating signals M1, M2 at the time of scanning the next row, so-called dot inversion driving can be realized.

FIG. 7 is a circuit diagram showing another embodiment of the above-mentioned video driving circuit 30 and corresponds to FIG. 6.

The constitution which makes this embodiment different from the embodiment shown in FIG. 6 lies in that a drain driver 311 from which the output signals Doa(i), Doa(i+1) assuming a positive polarity with respect to the center voltage Vcent are outputted and a drain driver 312 from which the output signals Dob(i), Dob(i+1) assuming a negative polarity with respect to the center voltage Vcent are outputted are provided separately from each other.

The video driving circuit 30 having such a constitution can obtain an advantageous effect that by making respective drain drivers 311, 312 separately input the power supply voltage and gray scale voltage corresponding to the gray scale data, the same type of driver can be used as respective drain drivers 311, 312.

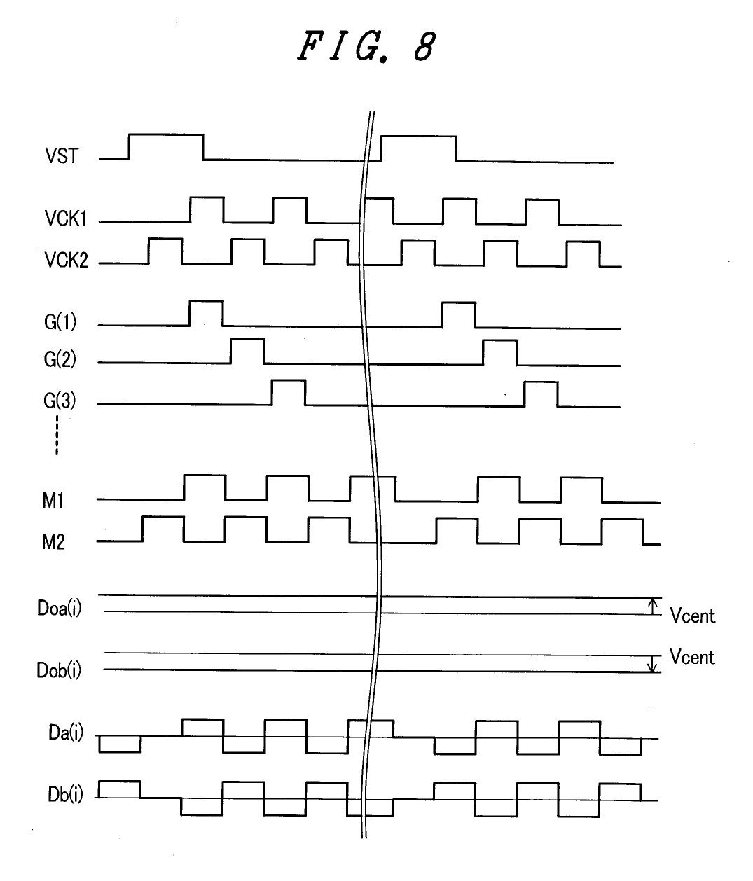

FIG. 8 is a timing waveform chart showing the scanning signals G(1), G(2), G(3), . . . video signals Doa(i), Dob(i), Da(i), Db(i) and the like when the video driving circuit 30 shown in FIG. 6 or FIG. 7 is used and corresponds to FIG. 3.

The constitution which makes this timing waveform chart different from the timing waveform chart shown in FIG. 3 is that the alternating signals M1, M2 and the output signals Doa(i), Dob(i) from the drain drivers 310, 311, 312 are additionally displayed in FIG. 3.

The alternating signals M1, M2 have polarities opposite to each other and these polarities are inverted every one selection period of the scanning signal. With respect to the output signal Doa(i) from the drain drivers 310, 311, 312, the output signal Doa(i) always assumes a positive polarity with respect to the center voltage Vcent, the output Dob(i) always assumes a negative polarity with respect to the center voltage Vcent. Further, the video signals Da(i), Db(i) respectively change the polarities thereof in response to the alternating signals M1, M2.

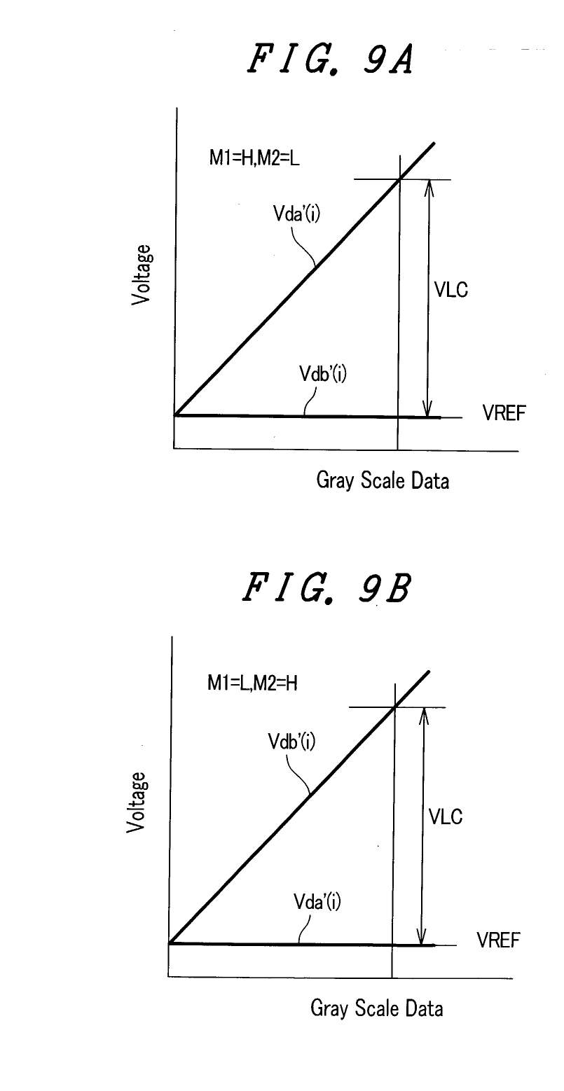

FIG. 9A and FIG. 9B are graphs showing another embodiment of the gray scale voltages Vda′(i), Vdb′(i) which are supplied to a pair of pixel electrodes and correspond to FIG. 4A and FIG. 4B.

The constitution which makes this embodiment different from the embodiment shown in FIG. 4A and FIG. 4B lies in that one gray scale voltage is increased with a positive gradient with respect to the gray scale data and another gray scale voltage assumes a reference voltage VREF which is a substantially fixed value.

Then, when the alternating signal M1 assumes “H” and the alternating signal M2 assumes “L”, the gray scale voltage Vda′(i) is increased with the positive gradient and the gray scale voltage Vdb′(i) assumes the reference voltage VREF which is substantially a fixed value. On the other hand, when the alternating signal M1 assumes “L” and the alternating signal M2 assumes “H”, the gray scale voltage Vdb′(i) is increased with the positive gradient and the gray scale voltage Vda′(i) assumes the reference voltage VREF which is substantially a fixed value.

Here, in the above-mentioned description, it has been explained that the respective gray scale voltages Vda′(i) and Vdb′(i) have characteristics that they are both in a rectilinear manner elevated with respect to the reference voltage VREF which is substantially a fixed value. However, the present invention is not limited to such a case and it is needless say that they may have the gently-curved characteristics. Further, the reference voltage VREF may be set larger than one gray scale voltage which is changed in response to the gray scale data.

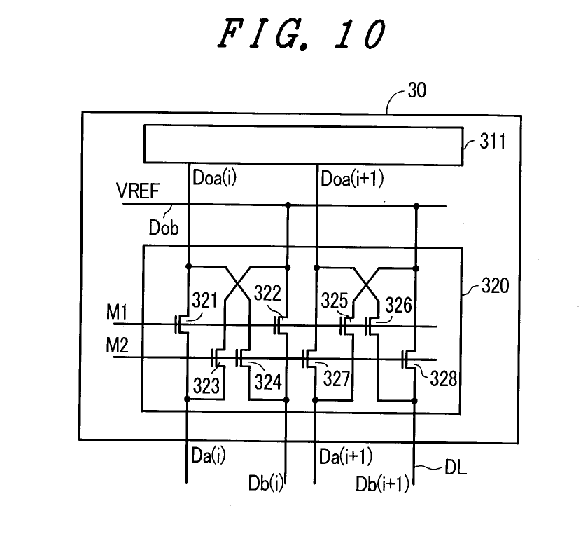

FIG. 10 is a circuit diagram showing another embodiment of the above-mentioned video driving circuit 30 and corresponds to FIG. 7.

The constitution which makes this embodiment different from the embodiment shown in FIG. 7 lies in that the drain driver 312 is not provided, and to the input of the alternating circuit 320, the terminal Dob which supplies the reference voltage VREF in place of the output signals Dob(i), Dob(i+1) from the drain driver 312 is connected.

From the video driving circuit 30 having such a constitution, the gray scale voltages Vda′(i) and Vdb′(i) having the characteristics shown in FIG. 9 are outputted.

Embodiment 2.

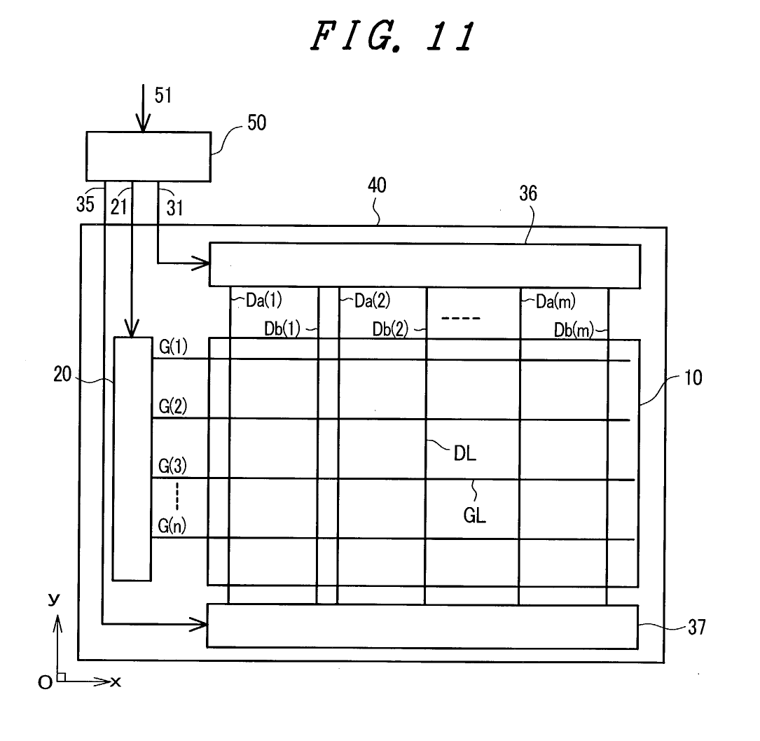

FIG. 11 is a schematic constitutional view showing another embodiment of the image display device according to the present invention and corresponds to FIG. 1.

The constitution which makes this embodiment 2 different from the embodiment shown in FIG. 1 lies in that a video driving circuit 36 is provided at one-extending-end side of the drain signal lines DL and a video driving circuit 37 is provided at another-extending-end side of the drain signal lines DL. Video driving control signals 35 are inputted to the video driving circuit 37 from a timing control circuit 50.

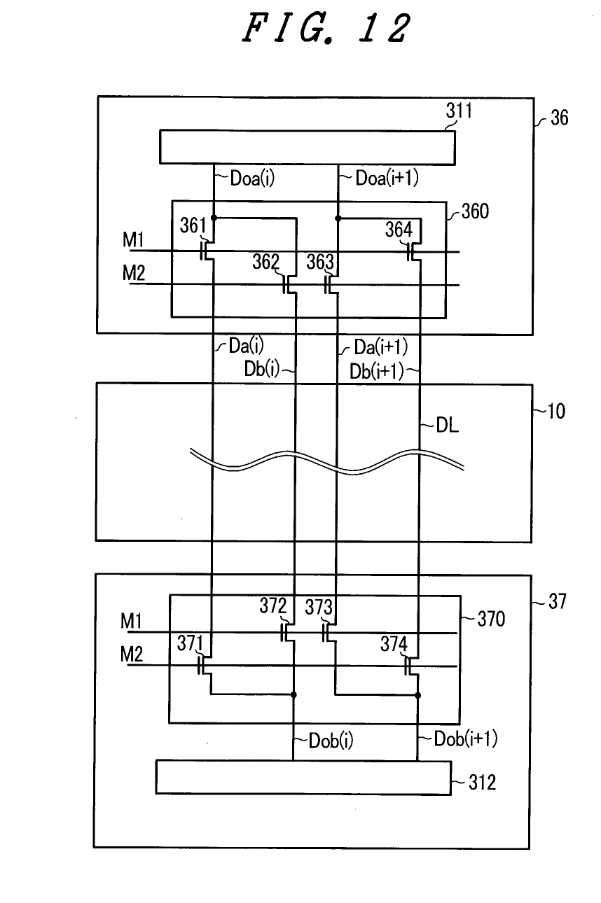

FIG. 12 is a circuit diagram showing one embodiment of constitutions of the video driving circuits 36 and 37 shown in FIG. 11 and corresponds to FIG. 7.

In FIG. 12, the video driving circuit 36 is constituted of the drain driver 311 and the alternating circuit 360.

The drain driver 311 is configured such that, in each pixel, out of video signals supplied to a pair of respective drain signal lines DL, one signals Doa(i), Doa(i+1) are outputted to the alternating circuit 360.

The alternating circuit 360 is constituted of transistors 361 to 364, wherein an ON/OFF control of the transistors 361, 364 is performed in response to the alternating signal M1 and an ON-OFF control of the transistors 362, 363 is performed in response to the alternating signal M2.

The video driving circuit 37 is constituted of a drain driver 312 and an alternating circuit 370.

The drain driver 312 is configured such that, in each pixel, out of video signals supplied to a pair of respective drain signal lines DL, another signals Dob(i), Dob(i+1) are outputted to the alternating circuit 370. Here, as the gray scale voltages Vda′(i), Vdb′(i), the voltages having characteristics shown in FIG. 4A and FIG. 4B are used.

The alternating circuit 370 is constituted of transistors 371 to 374, wherein an ON/OFF control of the transistors 371, 374 is performed in response to the alternating signal M2 and an ON-OFF control of the transistors 372, 373 is performed in response to the alternating signal M1.

To compare the video driving circuits 36, 37 having such constitutions with the constitution shown in FIG. 7, there is no possibility that the signal line led out from one drain driver runs through the inside of another drain driver and hence, an advantageous effect that a distance between output terminals of respective drain drivers 311, 312 can be narrowed is obtained.

Further, it is also possible to obtain an advantageous effect that the number of lines which have to be crossed in respective alternating circuits 360, 370 can be reduced.

Here, also in this embodiment, by skillfully arranging the transistors 361 to 364, 371 to 374, the polarities of the electric fields which are applied to liquid crystal of the pixels in the (i)th column and the pixels in the (i+1) column can be reversed.

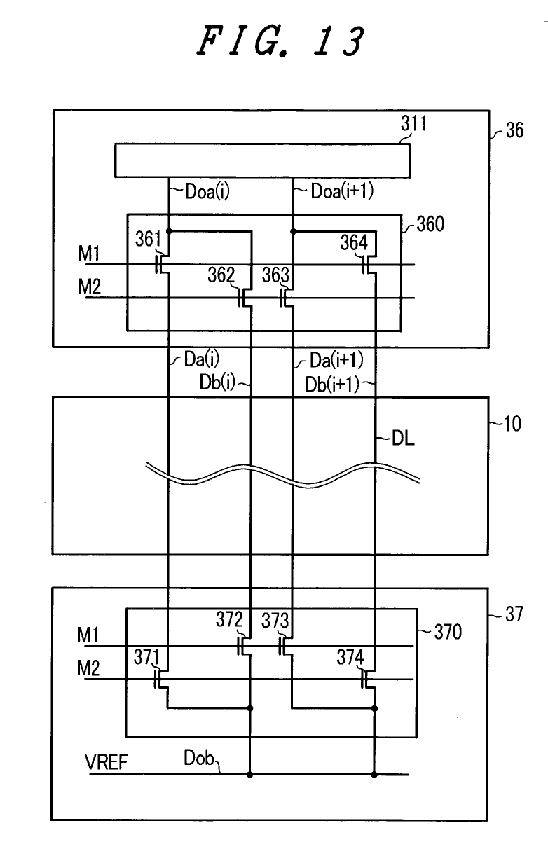

FIG. 13 is a circuit diagram showing another embodiment of constitutions of video driving circuits and corresponds to FIG. 12.

The constitution which makes this embodiment different from the embodiment shown in FIG. 12 lies in that without providing the drain driver 312 at the video driving circuit 37 side, the reference voltages VREF are supplied to all circuits in place of outputs from the drain driver 312. In this case, the gray scale voltages Vda′(i), Vdb′(i) having the characteristics shown in FIG. 9A and FIG. 9B are outputted from the video driving circuits 36, 37.

A wiring layer which supplies the reference voltage VREF can be formed without making this wiring layer and other wiring layer cross each other and hence, a large line width can be set whereby the reference voltage VREF of high accuracy can be obtained.

Embodiment 3.

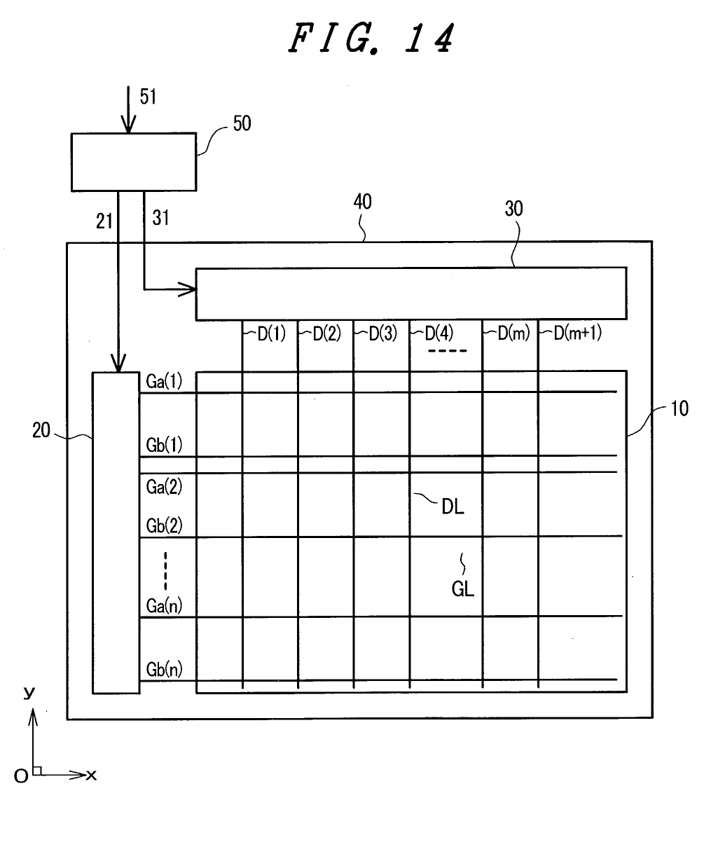

FIG. 14 is a schematic constitutional view showing another embodiment of the image display device according to the present invention and corresponds to FIG. 1.

The constitution which makes this embodiment different from the constitution shown in FIG. 1 lies in that respective signal lines which define one pixel are constituted of two gate signal lines GL and one drain signal line DL.

That is, respective gate signal lines GL are arranged such that, from the upper side in the drawing, the next gate signal line GL is arranged with respect to the first gate signal line GL with a relatively wide gap therebetween, and the further next gate signal line GL is arranged close to the next gate signal line GL, and the still further next gate signal line GL is arranged with respect to the further next gate signal line GL with a relatively wide gap therebetween, and such a relationship is repeated. Then, starting from the first gate signal line GL, the scanning signals Ga(1), Gb(1), Ga(2), Gb(2), . . . Gb(n) are sequentially supplied.

Further, respective drain signal lines DL are respectively arranged equidistantly and the video signals D(1), D(2), D(3), . . . , D(m+1) are sequentially supplied from the left side of the drawing.

Accordingly, in the pixel regions of n rows and m columns, 2n gate signal lines GL and (m+1) drain signal lines DL are provided.

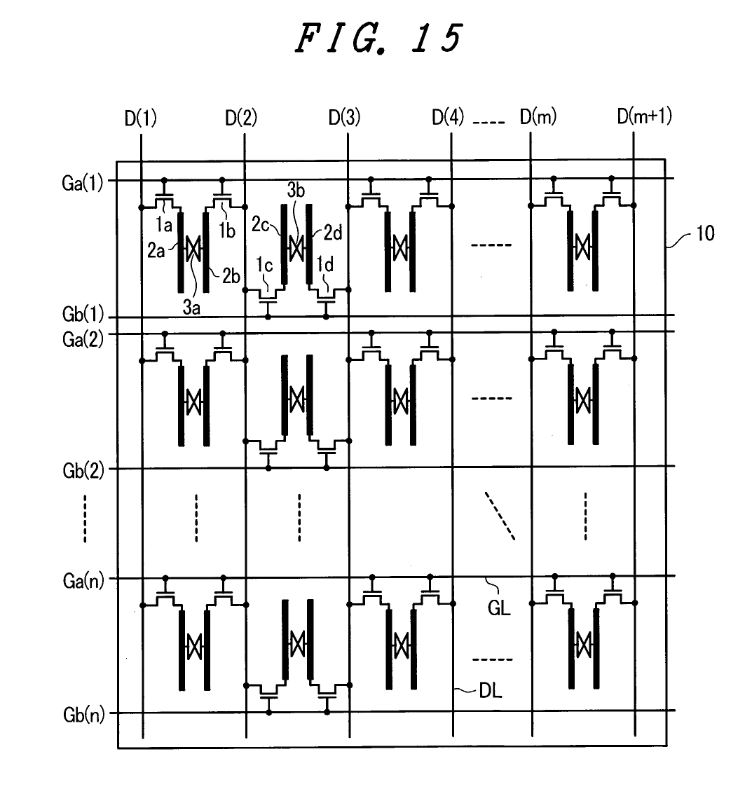

FIG. 15 is an equivalent circuit diagram showing one embodiment of the constitution of each pixel in the image display device shown in FIG. 14 and corresponds to FIG. 2.

The constitution which makes this equivalent circuit different from the equivalent circuit shown in FIG. 2 lies in that, first of all, in one pixel region, when the thin film transistors 1c, 1d are operated in response to the scanning signal Gb from the lower-side gate. signal line GL, respective thin film transistors 1a, 1b in the neighboring pixel regions at the left and right sides (x direction) are operated in response to the scanning signal Ga from the upper-side gate signal line GL.

Further, respective pixels which are arranged in the vertical direction are configured such that, in each pixel, respective thin film transistors 1a, 1b, 1c, 1d are operated in response to the scanning signal Gb from the lower-side gate signal line GL or the scanning signal Ga from the upper-side gate signal line GL.

Further, respective drain electrodes of a pair of respective thin film transistors 1a, 1b, 1c, 1d in each pixel are connected to one and another drain signal lines DL which define the pixel regions. Then, except for the drain signal lines DL arranged at both ends, the drain signal line DL between each two of pixels to which the video signals D(2) to D(m) are inputted is used in common by the pixel in the different column.

The pixel electrodes 2a, 2b, 2c, 2d are connected to respective source electrodes of respective thin film transistors 1a, 1b, 1c, 1d.

It is possible to operate the image display device having such a constitution basically in the same manner as the image display device shown in FIG. 2. Further, while increasing the number of the gate signal lines GL which is usually smaller than the number of the drain signal lines DL twice, the number of the drain signal lines DL is reduced to about half and hence, the number of signal lines can be reduced as a whole. Accordingly, it is possible to increase the area of each pixel so that the numerical aperture can be enhanced.

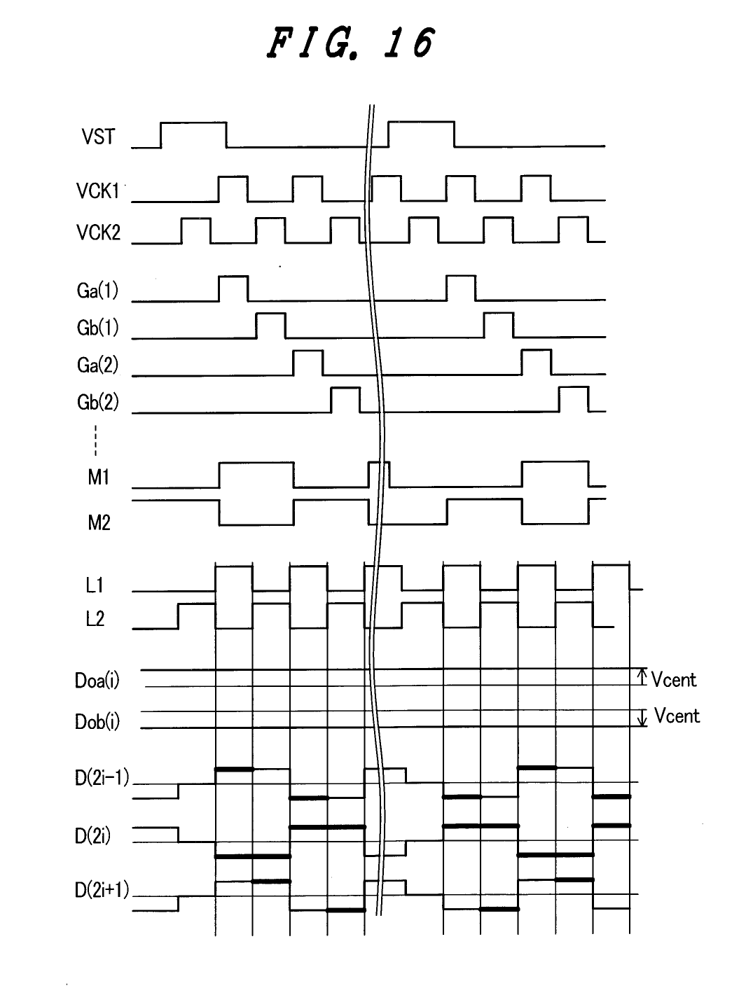

FIG. 16 is a timing waveform chart showing one embodiment of the relationship between the scanning signals Ga(1), Gb(1), Ga(2), Gb(2), . . . , the video signals D(2i−1), D(2i), D(2i+1) (i=1, 2, 3, . . . ) which are supplied to the pixel shown in FIG. 15 and corresponds to FIG. 8. Here, the drain line selection signals L1, L2 are explained later.

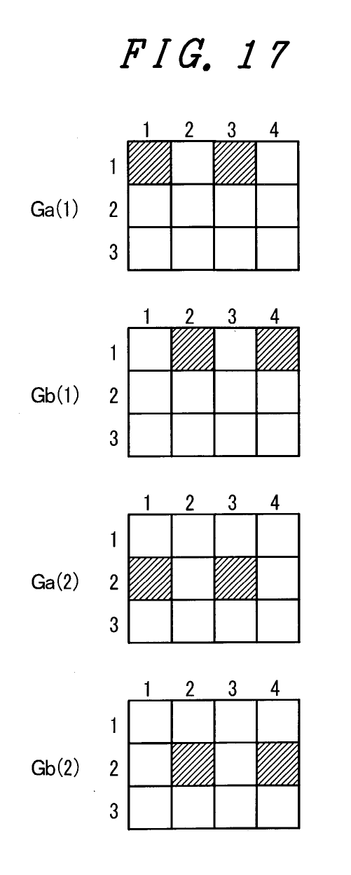

FIG. 17 is a view showing the sequence of writing a voltage in respective pixels shown in FIG. 15.

In this case, the pixels are expressed by 3×4, wherein when the scanning signal Ga(1) is applied, the pixels of the first row and odd columns are selected and the voltage is written in these pixels. Subsequently, when the scanning signal Gb(1) is applied, the pixels of the first row and even columns are selected and the voltage is written in these pixels. There after, with respect to pixels of the second and other following rows, the pixels are selected in the order of odd columns and even columns and the voltages are written in the pixels.

Here, portions indicated by a bold line among video signals D(2i−1), D(2i), D(2i+1) are voltages written in the selected pixels.

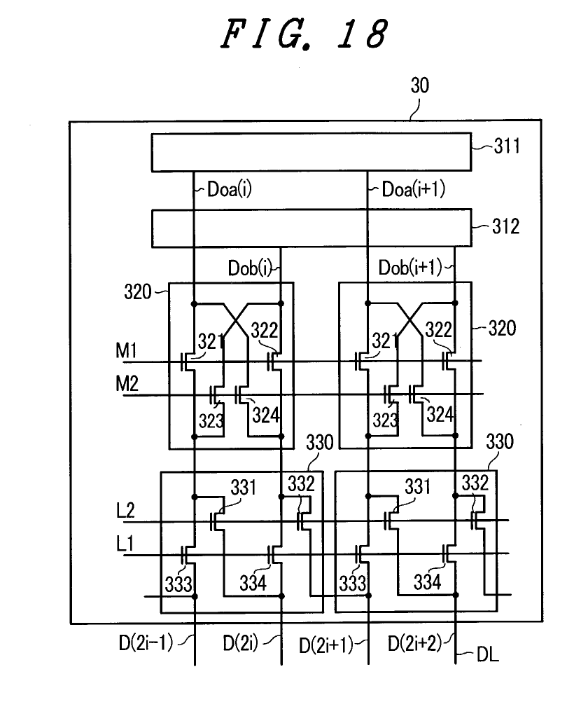

FIG. 18 is a circuit diagram showing one embodiment of the constitution of the video driving circuit 30 shown in FIG. 14 and corresponds to FIG. 7.

The constitution which makes this embodiment different from the constitution shown in FIG. 7 lies in that a drain line selection circuit 330 is newly added to the output of the alternating circuit 320.

The drain line selection circuit 330 is constituted of transistors 331 to 334, wherein a drain line selection signal L1 is supplied to the gate electrodes of the transistors 333, 334 and a drain line selection signal L2 is supplied to the gate electrodes of the transistors 331, 332.

The drain line selection signals L1, L2 are respectively inputted with the inversion relationship.

Then, when the drain line selection signal L1 assumes “H” and the drain line selection signal L2 assumes “L”, the transistors 333, 334 assume the ON state and the transistors 331, 332 assume the OFF state, while when the drain line selection signal L1 assumes “L” and the drain line selection signal L2 assumes “H”, the transistors 331, 332 assume the ON state and the transistors 333, 334 assume the OFF state.

Due to such a constitution, the outputs Doa(i), Dob(i) from the drain drivers 311, 312 are supplied in the normal sequence or in the reverse sequence by the alternating circuit 320 and, thereafter, when the drain line selection signal L1 assumes “H” and the drain line selection signal L2 assumes “L”, the outputs Doa(i), Dob(i) at the left side and the right side of the alternating circuit 320 are directly supplied to the drain signal lines DL as the video signals D(2i−1) and D(2i), while when the drain line selection signal L1 assumes “L” and the drain line selection signal L2 assumes “H”, the outputs are shifted to the next by one and are supplied to the drain signal lines DL as the video signals D(2i) and D(2i+1),

That is, the selection of the respective pixels which are arranged in a matrix array is, as shown in FIG. 17, enables the distribution of the video signals such that, in response to the scanning signals Ga(1), Ga(2), . . . from one gate signal line GL, for example, the pixels of odd columns are selected and hence, through a pair of drain signal lines Dl which are arranged at both sides of each pixel of odd columns, the video signals D(2i−1) and D(2i) are supplied to a pair of pixel electrodes 2a, 2b in the pixel, and thereafter, in response to the scanning signals Gb(1), Gb(2), . . . from the next gate signal line GL, for example, the pixels of even columns are selected and hence, through a pair of drain signal lines Dl which are arranged at both sides of each pixel of even column, the video signals D(2i) and D(2i+1) are supplied to a pair of pixel electrodes 2c, 2d in the pixel.

Such an operation can be achieved by adding the above-mentioned drain line selection circuit 330 to the conventional drain drivers 311, 312 and hence, it is possible to obtain an advantageous effect that the drain drivers 311, 312 can be used as it is.

Here, the drain driver 310 shown in FIG. 6 may be used in place of the drain drivers 311, 312. As gray scale voltages Vda′(i), Vdb′(i), the voltages having the characteristics shown in FIG. 4A and FIG. 4B are used.

FIG. 19 is a circuit diagram showing another embodiment of the constitution of the above-mentioned video driving circuit 30 and corresponds to FIG. 18.

The constitution which makes this embodiment different from the constitution shown in FIG. 18 lies in that terminals Dob which supply the reference voltage VREF are connected to the input of the alternating circuit 320 in place of the output Dob(i), Dob(i+1) from the drain driver 312.

Due to such a constitution, of a pair of drain signal lines DL which are arranged in a spaced-apart manner while sandwiching the pixel therebetween, the reference voltage VREF is supplied to one drain signal line DL as the video signal D and the gray scale voltage output Doa(i) which uses the reference voltage VREF as the reference is supplied to another drain signal line DL as the video signal D. As gray scale voltages Vda′(i), Vdb′(i), the voltages having the characteristics shown in FIG. 9A and FIG. 9B are used.

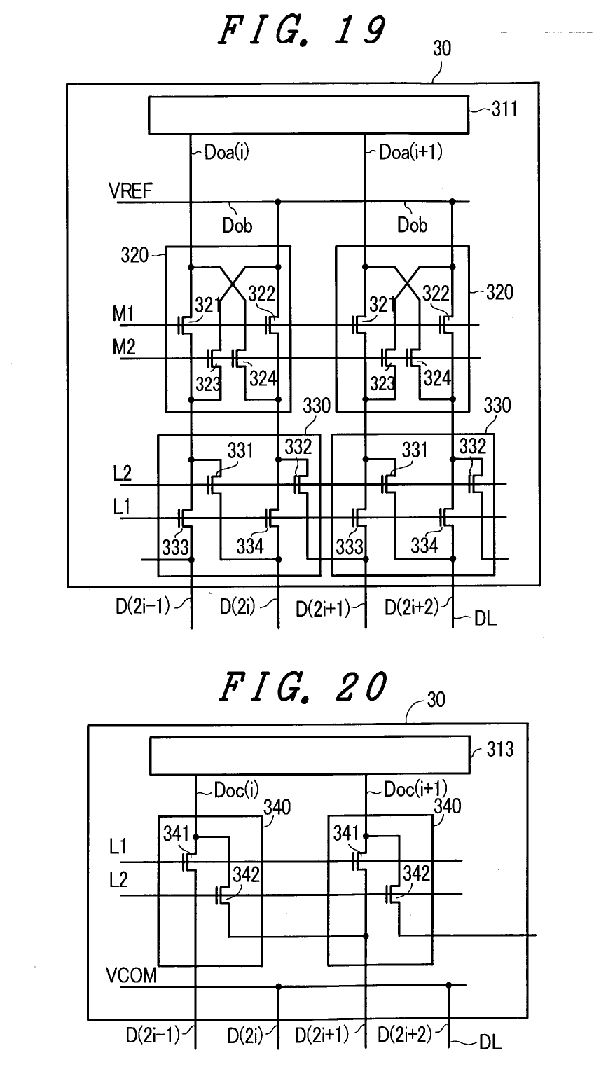

FIG. 20 is a circuit diagram showing another embodiment of the constitution of the above-mentioned video driving circuit 30 and corresponds to FIG. 19.

The constitution which makes this embodiment different from the constitution shown in FIG. 19 lies in that, first of all, the video driving circuit 30 is not provided with the alternating circuit 320. Further, the video driving circuit 30 includes drain line selection circuits 340 which connect the drain signal lines DL of even columns to which the video signals D(2i) are supplied to a common voltage VCOM and select the drain signal lines DL of odd columns.

Here, the common voltage VCOM may be connected to the drain signal lines DL of odd columns in place of the drain signal lines DL of even columns.

The drain line selection circuit 340 is configured to output the output Doc(i) from the drain driver 313 directly as the video signal D(2i−1) or as the video signal D(2i+1) by shifting by one in response to the drain line selection signals L1, L2.

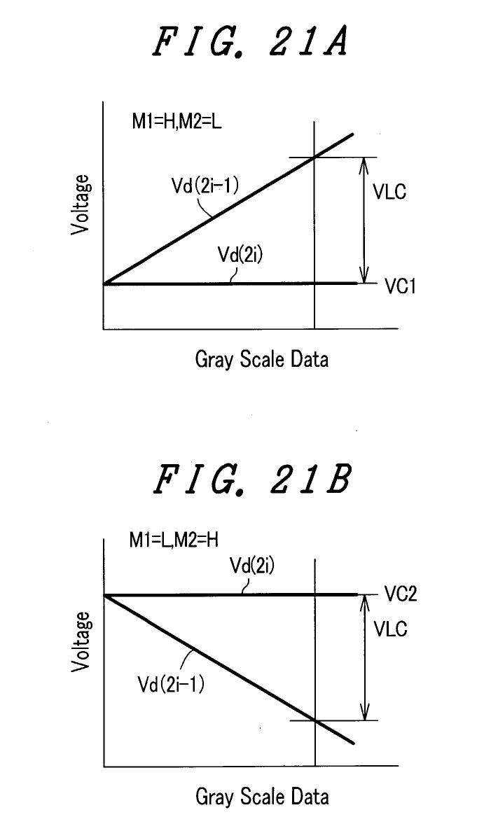

FIG. 21A to FIG. 21B are views showing the relationship between the gray scale data and the video signals used in the video driving circuit 30 shown in FIG. 20.

The video signals Vd(2i) in the drain signal lines DL of even columns assume two states indicated by VC1 in FIG. 21A and VC2 in FIG., 21B by changing over the alternating signals M1, M2 without depending on the gray scale data.

On the other hand, the video signals Vd(2i−1) in the drain signal lines DL of odd columns are set such that the signals are changed with respect to the gray scale data with a positive or negative gradient using the above-mentioned two voltage stages VC1, VC2 as the references.

Here, in the drain driver 313, the polarities of the output Doc(i) is changed over so as to perform the operations shown in these drawings in response to the alternating signals M1, M2.

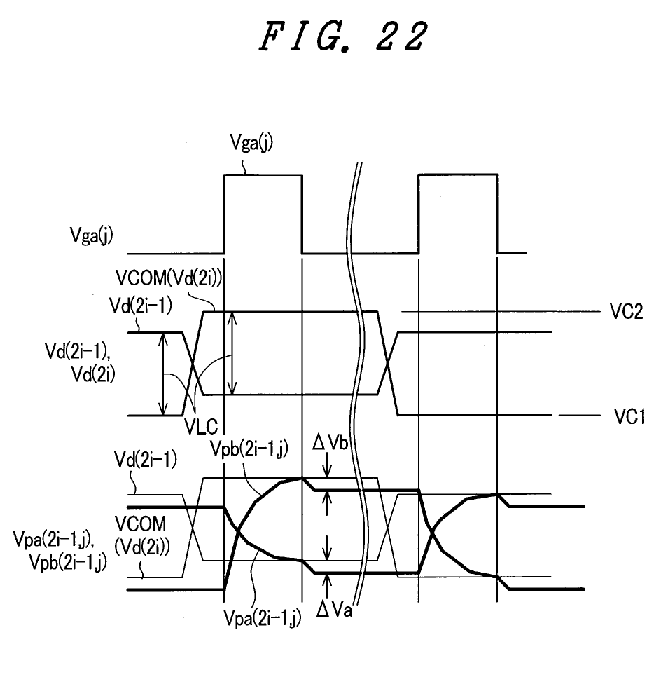

FIG. 22 is a timing waveform chart showing the relationship among the gate line voltage, drain line voltages and the pixel voltage supplied to each pixel in the video driving circuit 30 shown in FIG. 20.

In the drawing, the gate line voltage Vga(j) which selects the pixels of j row and odd columns, the drain line voltages Vd(2i−1), Vd(2i) of (2i−1) row and (2i) column, and the pixel voltages Vpa(2i−1, j), Vpb(2i−1, j) of a pair of pixel electrodes 2a, 2b of pixels of j row and (2i−1) column are indicated.

The common voltage VCOM which is supplied to the drain signal lines DL of even rows assume two voltage states VC1, VC2 and are configured to be changed over every frame period. Further, as the output voltage Vdoc(i) of the drain driver 313, the voltage which assumes a positive polarity or a negative polarity with respect to the common VCOM is supplied. The polarity is changed over at a cycle equal to the changeover cycle of the common voltage VCOM. The voltage differene between the output voltage Vdoc(i) and the common voltage Vcom constitutes the liquid crystal driving voltage VLC.

The pixel voltages Vpa(2i−1, j), Vpb(2i−1, j) of a pair of pixel electrodes 2a, 2b are configured to respond such that when the gate line voltage Vga(j) assumes “H”, the pixel voltages Vpa(2i−1, j), Vpb(2i−1, j) become respectively equal to the drain line voltages Vd(2i−1), Vd(2i).

Further, when the gate voltage Vga(j) is changed from “H” to “L”, the pixel voltages Vpa(2i−1, j), Vpb(2i−1, j) are respectively changed by ΔVa, ΔVb due to the feed-through. This voltage changes ΔVa, ΔVb due to the feed-through depend on amplitudes of the voltage of the drain signal line DL and the voltage of the gate signal line GL.

Embodiment 4.

FIG. 23 is a schematic constitutional view showing another embodiment of the image display device according to the present invention and corresponds to FIG. 1.

The constitution which makes this embodiment different from the embodiment shown in FIG. 1 lies in that respective regions which are surrounded by gate signal lines GL which extend in the x direction and are arranged in parallel in the y direction and drain signal lines DL which extend in the y direction and are arranged in parallel in the x direction constitute the pixel regions.

Further, the image display device includes counter voltage signal lines CL which run through respective pixel regions arranged in the x direction and common signals C(1) to C(n) are supplied to these counter voltage signal lines CL from a common circuit 60. Accordingly, with respect to the pixel regions having the matrix array of n rows and m columns, n pieces of gate signal lines GL, m pieces of drain signal lines DL and n pieces of counter voltage signal lines CL are provided.

Here, control signals 61 are inputted to the common circuit 60 from the timing control circuit 50.

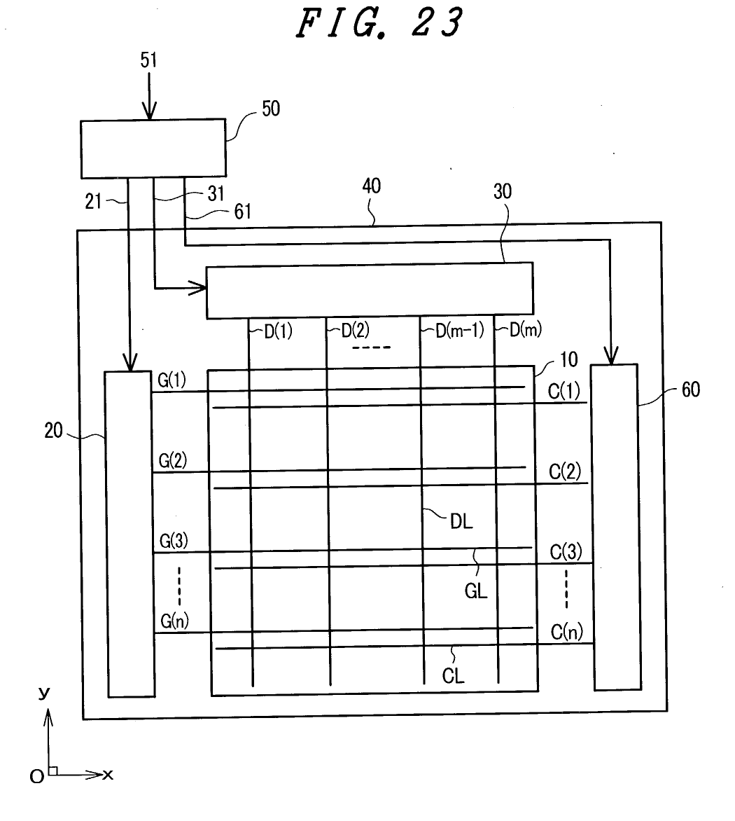

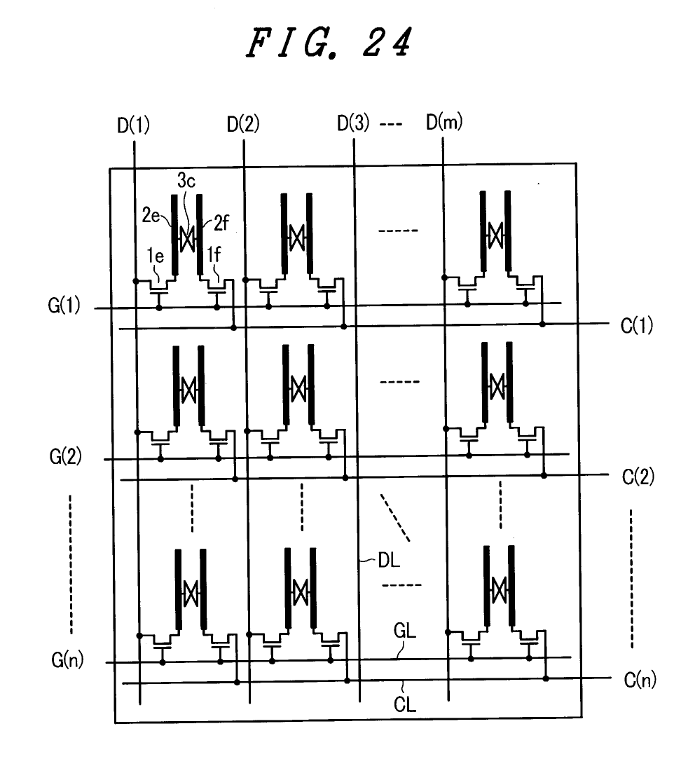

FIG. 24 is an equivalent circuit diagram showing one embodiment of the constitution of the pixel of the image display device shown in FIG. 23.

In each pixel region, there are provided a pair of thin film transistors 1e, If which are operated in response to the scanning signal G(i) (i=1, 2, 3, . . . ) from the gate signal line GL, a pixel electrode 2e to which the video signals D(1) to D(m) are supplied from the drain signal line DL arranged at one side through the thin film transistor 1e, and a pixel electrode 2f to which the common signals C(1) to C(n) are supplied from the counter voltage signal line CL through the thin film transistor 1f.

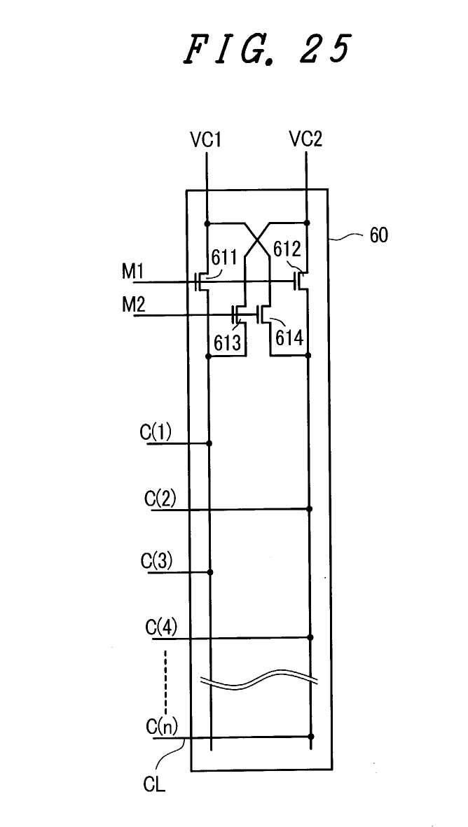

FIG. 25 is a circuit diagram showing one embodiment of the constitution of the common circuit 60 shown in FIG. 23.

The common circuit 60 is constituted of transistors 611 to 614 and the common voltage VC1, VC2 and alternating signals M1, M2 are inputted.

Here, the alternating signal M1 is served for operating the transistors 611 and 612, while the alternating signal M2 is served for operating the transistors 613 and 614.

With respect to these alternating signals M1, M2, when the alternating signal M1 assumes “H” and the alternating signal M2 assumes “L”, for example, the common voltage VC1 is supplied to the counter voltage signal lines CL of odd rows, while the common voltage VC2 is supplied to the counter voltage signal lines CL of even rows.

Further, when the alternating signals are inverted and when the alternating signal M1 assumes “L” and the alternating signal M2 assumes “H”, the common voltage VC1 is supplied to the counter voltage signal lines CL of even rows, while the common voltage VC2 is supplied to the counter voltage signal lines CL of odd rows.

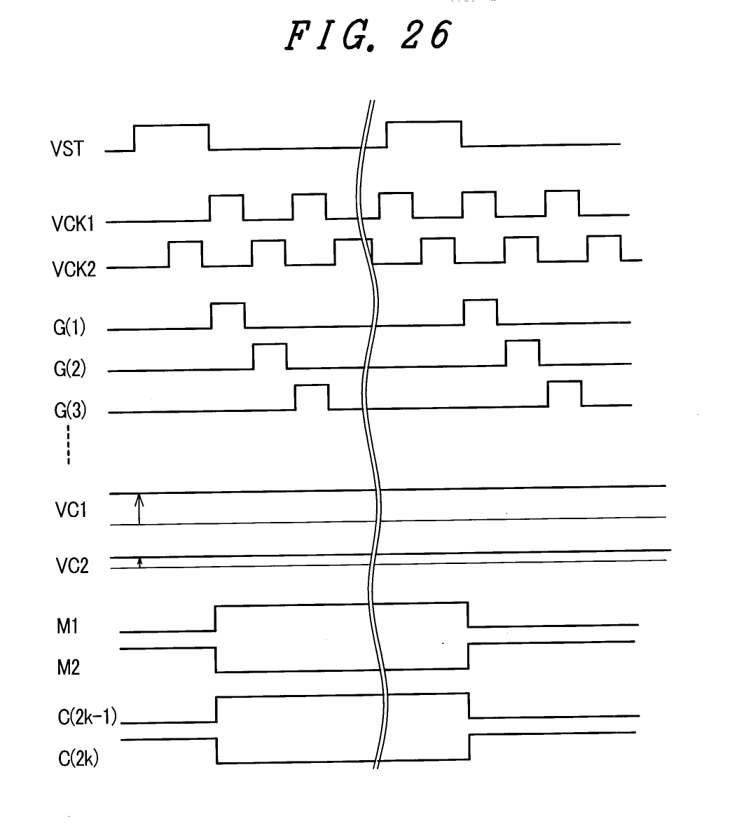

FIG. 26 is a timing waveform chart of the scanning signals G(i), the common voltages VC1, VC2, the alternating signals M1, M2, the common signals C(2k−1) which are supplied to the counter voltage signal lines CL of odd rows, and the common signals C(2k) which are supplied to the counter voltage signal lines CL of even rows of the image display device shown in FIG. 23.

The scanning signals G(1), G(2), G(3), . . . which are supplied to respective gate signal lines GL are configured to sequentially change phases thereof in synchronism with clock signals VCK1, VCK2.

Further, as the common voltages VC1, VC2, the substantially fixed DC voltages which differ in voltage from each other are inputted, and the alternating signals M1, M2 repeat the “H” state and the “L” state alternately in synchronism with start signals VST.

The common signals C(2k−1) which are supplied to the counter voltage signal lines CL of odd rows and the common signals C(2k) which are supplied to the counter voltage signal lines CL of even rows are configured to change at the same phases as the alternating signals M1, M2.

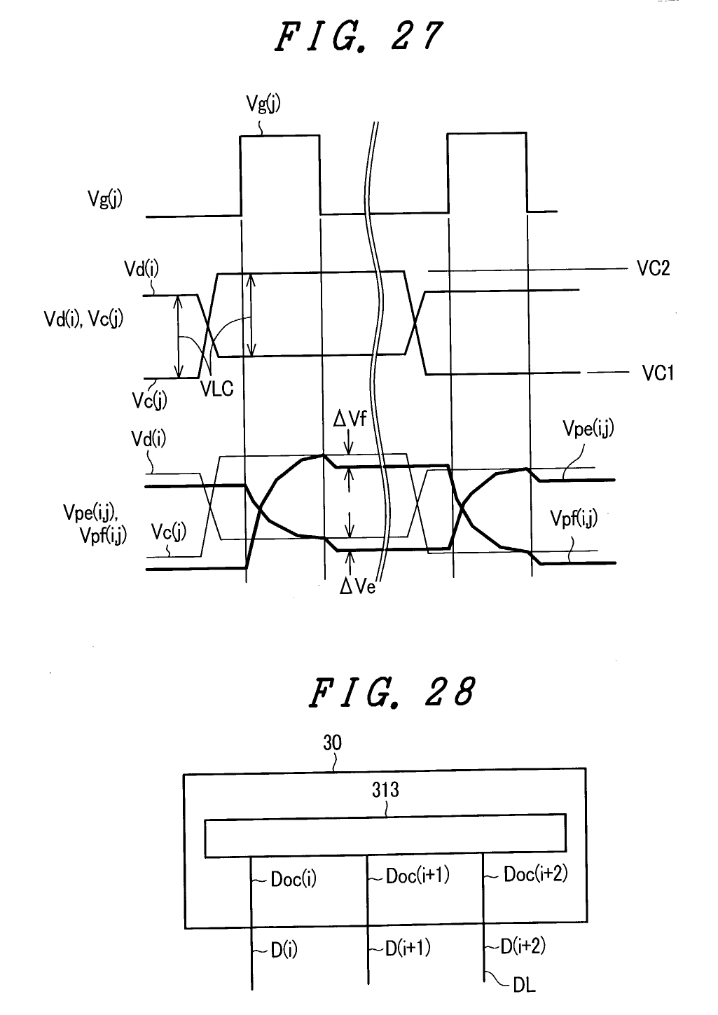

FIG. 27 is a timing waveform chart showing the relationship among the gate line voltage Vg(j) of j row which is supplied to the pixels shown in FIG. 24, the drain line voltage Vd(i) of row (i), the counter voltage signal line voltage Vc (j) of j row, and the pixel voltages Vpe(i,j), Vpf(i,j) of the pixel electrodes 2e, 2f of the pixel region of j row and i column.

The drain line voltage Vd(i) is applied such that the difference between the drain line voltage Vd(i) and the counter voltage signal line voltage Vc(j) assumes the liquid crystal driving voltage VLC.

The pixel voltages Vpe(i,j), Vpf(i,j), when the gate line voltage Vg(i) assumes “H”, respond such that they assume the same values as the drain signal line voltage Vd(i) and the counter voltage signal line voltage Vc (j) respectively and are lowered by ΔVe, ΔVf respectively at a point of time that the gate line voltage Vg(i) is changed to “L” and, thereafter, they are held at the lowered voltages. Here, the voltage changes ΔVe, ΔVf are generated by the feed-through.

FIG. 28 is a circuit diagram showing one embodiment of the constitution of the video driving circuit 30 shown in FIG. 23.

The video driving circuit 30 includes a drain driver 313 and its outputs Doc(i), Doc(i+1), Doc(i+2), . . . are respectively outputted to respective drain signal lies DL as video signals D(i), D(i+1), D(i+2), . . . .

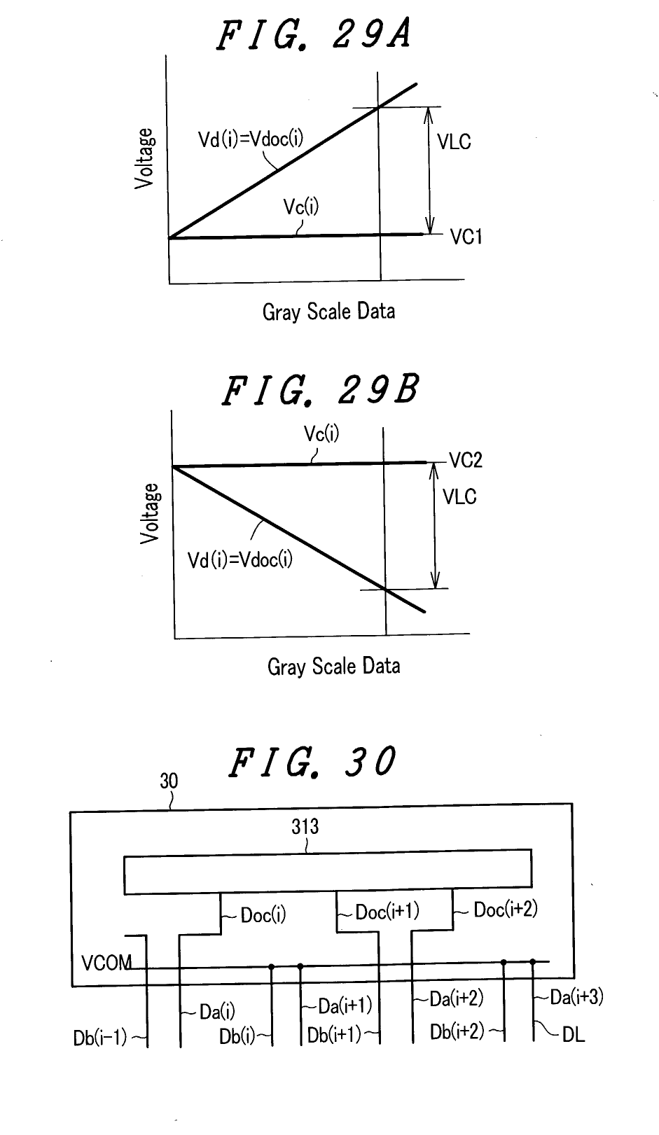

In this case, respective video signals D(i), D(i+1), D(i+2), . . . have polarities thereof changed every 1 horizontal period and are changed over between a case in which these signals take a positive polarity with respect to the common voltage VC1 as shown in FIG. 29A and a case in which these signals take a negative polarity with respect to the common voltage VC2 as shown in FIG. 29B.

Here, in FIG. 29A and 29B, Vc(i) indicates a common voltage supplied to the counter voltage signal lines CL, Vd(i) indicates a voltage of the video signal D(i) supplied to the drain signal line DL, and Vdoc(i) indicates a voltage of an output Doc(i) from a drain driver 313.

The changeover of the output Doc(i) from the drain driver 313 for every 1 horizontal period is configured to correspond to the distribution of VC1, VC2 for every row in the common circuit 60 shown in FIG. 25.

In view of the above, the period (every frame period) of the alternating signals M1, M2 of the common circuit 60 and the alternating period (every 1 horizontal period) of the drain driver 313 are made different from each other.

Although the polarity of the counter voltage signal line CL is changed over every 1 row in the common circuit 60 in the above-mentioned embodiment, it is needless to say that the polarity of the counter voltage signal line CL can be changed over every 2 rows or every 3 or more rows.

Here, the alternating period of the drain driver 313 is also set to every 2 horizontal periods or every 3 or more horizontal periods corresponding to the above-mentioned changeover of the polarity of the counter voltage signal line CL.

Embodiment 5.

FIG. 30 shows a circuit diagram showing another embodiment of the constitution of the video driving circuit 30 described in the embodiment 1.

This embodiment is configured such that, of a pair of pixel electrodes 2a, 2b, a voltage of a common voltage VCOM is written in one pixel electrode and an output of the drain driver 313 is written in another pixel electrode.

Further, the voltage of the common voltage VCOM is configured to be changed over between two states of VC1 or VC2 in response to alternating signals M1, M2 not shown in the drawing.

Then, an output Doc(i) from the drain driver 313 is also changed over between two cases, that is, a case in which the output Doc(i) assumes a positive polarity with respect to the voltage VC1 and in which the output Doc(i) assumes a negative polarity with respect to the voltage VC2 in response to the alternating signals M1, M2 in the same manner.

Such a constitution is similar to the constitutions which are described in conjunction with FIG. 21A and FIG. 21B as well as FIG. 29A and FIG. 29B. Here, different from the case shown in FIG. 28, the common voltage VCOM and the output Doc(i) of the drain driver 313 are changed over at the same alternating period.

In this embodiment, the output Doc(i) of the drain driver 313 is outputted as the video signals Da(i) and the output Doc(i+2) of the drain driver 313 is outputted as the video signal Da(i+2) to the left-side drain signal line DL in one pixel. However, the output Doc(i+1) of the drain driver 313 may be outputted as the video signal Db(i+1) for the right-side drain signal line DL in one pixel.

The reason that the drain signal lines DL are connected in a zigzag manner is to reverse the polarities of voltages applied to neighboring pixels as pixels of different columns. Accordingly, even when the outputs Doc(i), Doc(i+1), Doc(i+2) from the drain driver 313 may have the same polarity, it is possible to apply voltages of reverse polarities to the neighboring pixels.

Although the image display devices which have been explained heretofore are explained by taking the liquid crystal display device as an example, it is needless to say that the present invention is applicable to other image display device such as an image display device which uses EL (Electro Luminescence).

Further, in the above-mentioned respective embodiments, to focus on one pixel, it is preferable to change over the polarities of the voltages for every 1 frame. However, it is possible to change over the polarities of voltages for every 2 frames. Further, with respect to the gray scale voltage, the liquid crystal driving voltage VLC may be reduced corresponding to the increase of the gray scale data.

As can be clearly understood from the foregoing description, according to the image display device of the present invention, it is possible to simplify the driving of the image display device.

What is claimed is:

1. An image display device comprising:
a plurality of pixels which are arranged in a matrix array, each pixel including a first pixel electrode and a second pixel electrode; and
a circuit which applies a first voltage which assumes either a positive polarity or a negative polarity with respect to a center voltage which is substantially fixed irrelevant to gray scale data and changes a magnitude thereof in response to the gray scale data to the first pixel electrode and, at the same time, applies a second voltage which assumes the other polarity with respect to the center voltage and changes a magnitude thereof in response to the gray scale data to the second pixel electrode.

2. An image display device according to claim 1, wherein the circuit inverts the polarity of the second voltage with respect to the first voltage in each pixel for every one frame or two or more frames.

3. An image display device according to claim 1, wherein each pixel includes a first switching element and a second switching element, the first voltage is written in the first pixel electrode through the first switching element, and the second voltage is written in the second pixel electrode through the second switching element.

4. An image display device comprising:
a plurality of pixels which are arranged in a matrix array of n rows and m columns;
n pieces of gate signal lines;
2m pieces of drain signal lines, wherein two drain signal lines consisting of a first drain signal line and a second drain signal line are made to correspond to one row of the plurality of pixels; and
a video driving circuit which applies a first signal to the first drain signal lines and a second signal to the second drain signal lines, wherein
each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element,
the first signal is a first voltage which is a voltage having either a positive polarity or a negative polarity with respect to a center voltage which is substantially fixed irrelevant to gray scale data and changes a magnitude thereof in response to the gray scale data, and
the second signal is a second voltage which is a voltage having the other polarity with respect to the center voltage and changes a magnitude thereof in response to the gray scale data.

5. An image display device according to claim 4, wherein the video driving circuit includes an alternating circuit which inverts the polarity of the second signal with respect to the first signal applied to each drain signal line for every one frame or two or more frames.

6. An image display device comprising:
a plurality of pixels which are arranged in a matrix array of n rows and m columns;
n pieces of gate signal lines; 2m pieces of drain signal lines, wherein two drain signal lines consisting of a first drain signal line and a second drain signal line are made to correspond to one row of the plurality of pixels; and
a video driving circuit which applies a first signal to the first drain signal lines and a second signal to the second drain signal lines, wherein
each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element,
the first signal is either a reference voltage which is substantially fixed irrelevant to gray scale data or a first voltage which has one polarity with respect to the reference voltage and changes a magnitude thereof in response to the gray scale data, and
the second signal is the other voltage.

7. An image display device according to claim 6, wherein the video driving circuit includes an alternating circuit which changes over the first signal applied to the first drain signal line to either the reference voltage or the first voltage for every one frame or two or more frames.

8. An image display device comprising:
a plurality of pixels which are arranged in a matrix array of n rows and m columns;
n pieces of gate signal lines;
2m pieces of drain signal lines, wherein two drain signal lines consisting of a first drain signal line and a second drain signal line are made to correspond to one row of the plurality of pixels; and
a video driving circuit which applies a first signal to the first drain signal lines and a second signal to the second drain signal lines, wherein
each pixel includes a first switching element and a second switching element which are operated in response to the common gate signal line, a first pixel electrode to which the first signal is supplied from the first drain signal line through the first switching element, and a second pixel electrode to which the second signal is supplied from the second drain signal line through the second switching element, and
the video driving circuit changes over
a first state in which the first signal is either a first reference voltage which is substantially fixed irrelevant to gray scale data or a first voltage which has one polarity with respect to the first reference voltage and changes a magnitude thereof in response to the gray scale data, and the second signal is the other voltage, and
a second state in which the first signal is either a second reference voltage which is substantially fixed irrelevant to the gray scale data and is different from the first reference voltage or a second voltage which has another polarity with respect to the second reference voltage and changes a magnitude thereof in response to the gray scale data, and the second signal is the other voltage.

9. An image display device according to claim 8, wherein the video driving circuit changes over the first state and the second state for every one frame or two or more frames.

10. An image display device comprising:
a plurality of pixels which are arranged in a matrix array of n rows and m columns;
n pieces of first gate signal lines to which scanning signals for pixels of odd columns out of the plurality of pixels are applied;
n pieces of second gate signal lines to which scanning signals for pixels of even columns out of the plurality of pixels are applied;
(m+1) pieces of drain signal lines in which the first drain signal line is used corresponding to the pixels of the first column, the (m+1)th drain signal line is used corresponding to the pixels of the (m)th column, and each drain signal line from the second to (m)th drain signal lines is used in common for columns of pixels which are arranged at both sides of the drain signal line whereby two drain signal lines correspond to one pixel;
a scanning driving circuit which applies the scanning signals to the first gate signal lines and the second gate signal lines, and
a video driving circuit which applies video signals to the drain signal lines.

11. An image display device according to claim 10, wherein each pixel includes a first switching element and a second switching element which are operated in response to the common first gate signal line or second gate signal line, a first pixel electrode to which the video signal is supplied from corresponding one drain signal line through the first switching element, and a second pixel electrode to which the video signal is supplied from corresponding another drain signal line through the second switching element.

12. An image display device according to claim 10, wherein the video signal which is applied to one drain signal line out of two drain signal lines which correspond to one pixel is a first voltage which is a voltage having either a positive polarity or a negative polarity with respect to a center voltage which is substantially fixed irrelevant to gray scale data and changes a magnitude thereof in response to the gray scale data, and
the video signal which is applied to the other drain signal line out of two drain signal lines which correspond to one pixel is a second voltage which is a voltage having the other polarity with respect to the center voltage and changes a magnitude thereof in response to the gray scale data.

13. An image display device according to claim 12, wherein the video driving circuit includes an alternating circuit which inverts the polarity of the video signal applied to one drain signal line with respect to the video signal applied to the other drain signal line for every one frame or two or more frames.

14. An image display device according to claim 10, wherein the video signal which is applied to one drain signal line out of two drain signal lines which correspond to one pixel is either a reference voltage which is substantially fixed irrelevant to gray scale data or a first voltage which has one polarity with respect to the reference voltage and changes a magnitude thereof in response to the gray scale data, and
the video signal which is applied to the other drain signal line out of two drain signal lines which correspond to one pixel is the other voltage.

15. An image display device according to claim 14, wherein the video driving circuit includes an alternating circuit which changes over the video signal applied to one drain signal line to either the reference voltage or the first voltage for every one frame or two or more frames.

16. An image display device according to claim 10, wherein the video driving circuit changes over
a first state in which the video signal which is applied to one drain signal line out of two drain signal lines which corresponds to one pixel is either a first reference voltage which is substantially fixed irrelevant to gray scale data or a first voltage which has one polarity with respect to the first reference voltage and changes a magnitude thereof in response to the gray scale data, and the video signal which is applied to the other drain signal line out of two drain signals which correspond to one pixel is the other voltage, and
a second state in which the video signal which is applied to one drain signal line out of two drain signal lines which correspond to one pixel is either a second reference voltage which is substantially fixed irrelevant to the gray scale data and is different from the first reference voltage or a second voltage which has the other polarity with respect to the second reference voltage and changes a magnitude thereof in response to the gray scale data, and the video signal which is applied to the other drain signal line out of two drain signal lines which correspond to one pixel is the other voltage.

17. An image display device according to claim 16, wherein the video driving circuit changes over the first state and the second state for every one frame or two or more frames.

18. An image display device comprising a plurality of pixels which are arranged in a column direction as well as in a row direction, wherein
gate signal lines which select respective pixels arranged in odd columns and gate signal lines which select respective pixels arranged in even columns are separately provided, and
each pixel includes a pair of switching elements which are operated in response to scanning signals from the gate signal line, and a pair of pixel electrodes to which video signals are supplied from respective drain signal lines which are respectively arranged at both sides of the pixel through the pair of switching elements.

19. An image display device according to claim 18, wherein each pixel arranged in the row direction is positioned between the gate signal line which selects each pixel arranged in the odd column in the row and the gate signal line which selects each pixel arranged in the even column in the row.

20. An image display device according to claim 18, wherein out of the respective drain signal lines, from the drain signal lines at one side, signals which constitute the reference with respect to the video signals of the drain signal lines at the other side are supplied.

21. An image display device comprising:
a plurality of pixels which are arranged in a matrix array of n rows and m columns;
n pieces of gate signal lines;
m pieces of drain signal lines; and
n pieces of counter voltage signal lines which are formed along the extending direction of the gate signal lines, wherein
each pixel includes a first switching element and a second switching element which are operated in response to the common gate signal line, a first pixel electrode to which video signals are supplied from the drain signal line through the first switching element, and a second pixel electrode to which a reference voltage is supplied from the counter voltage signal line through the second switching element, and
a first reference voltage and a second reference voltage which differ from each other in voltage are alternately supplied to the counter voltage signal lines every one or more lines.

22. An image display device according to claim 21, wherein the image display device includes a video signal driving circuit which changes over polarities of the video signals to be applied to the drain signal lines every horizontal period which is equal to the number of alternating first reference voltage and second reference voltage.

23. An image display device according to claim 21, wherein the image display device includes a common circuit which changes over the reference voltage applied to respective counter voltage signal lines from one to the other out of the first reference voltage and the second reference voltage for every one frame or two or more frames.

24. An image display device according to claim 1, wherein the pixels are pixels of a liquid crystal display device.
